(19) United States
(12) Patent Application Publication
(10) Pub. No.: US 2018/0225837 A1
(43) Pub. Date: Aug. 9, 2018

(54) SCENARIO EXTRACTION METHOD, OBJECT LOCATING METHOD AND SYSTEM THEREOF

(71) Applicant: TIANJIN SHARPNOW TECHNOLOGY CO., LTD., Tianjin (CN)

(72) Inventors: Jinsu LIU, Tianjin (CN); Jiongkun XIE, Tianjin (US)

(73) Assignee: Tianjin Sharpnow Technology Co., Ltd., Tianjin (CN)

(21) Appl. No.: 15/750,196

(22) PCT Filed: Jul. 27, 2016
(86) PCT No.: PCT/CN2016/091967

§ 371 Date: Feb. 4, 2018

(30) Foreign Application Priority Data
Aug. 4, 2015 (CN) 201510469539.6

(51) Int. Cl. G06T 7/55; G06T 7/73

(52) U.S. Cl. CPC G06T 7/55; G06T 19/006; G06T 7/73

(57) ABSTRACT

Disclosed are a scenario extraction method, an object locating method and a system thereof. The disclosed scenario extraction method comprising: capturing a first image of a real scenario; extracting a plurality of first features from the first image, each of the plurality of first features having a first location; capturing a second image of the real scenario, extracting a plurality of second features from the second image; each of the plurality of second features having a second location; based on the movement information, estimating a first estimated location of each of the plurality of first features using the plurality of first locations; and selecting the second feature having the second location near the first estimated location as a scenario feature of the real scenario.

### FIELD OF THE INVENTION

The present invention relates to VR (virtual reality) technology. Particularly, the present invention relates to the method for extracting scenario feature and determining the pose of an object in a scenario based on a video capture device and the system thereof.

### BACKGROUND OF THE INVENTION

Immersive virtual reality system combines the latest achievements in the fields of computer graphics technique, wide-angle stereo display technique, sensory tracking technique, distributed computing, artificial intelligence and etc, a virtual world is generated through computer simulation, and is presented in front of the user, to provide to the user with verisimilar audio-visual experience, enabling the user to be whole-heartedly immersed in the virtual world thereof. When what the user sees and hears is as real as the real world, the user will naturally interact with the virtual world. In three-dimensional space (real physical space, computer-simulated virtual space or the combination of both), the user can move and perform interaction, and such a human-machine interaction is called 3D Interaction. Three-dimensional interaction is common in 3D modeling software tool, such as CAD, 3Ds MAX, Maya and etc. However, the interactive input device thereof is a 2D input device (e.g., a mouse), which greatly limits the user's freedom to make natural interaction with the 3D virtual world. In addition, the output thereof is generally a flat projection image of a three-dimensional model, even though the input device is a three-dimensional device (e.g., a somatosensory device), it is still difficult for the user to intuitively and naturally feel the operation of a three-dimensional model. The user can only experience air interaction through the traditional way of three-dimensional interaction.

As head-mounted virtual reality devices become mature in all technical aspects, immersive virtual reality brings a feeling of presence to users, while making the demand of users to experience 3D interaction to a new level. Users are no longer satisfied with the traditional way of air interaction, but they require that the three-dimensional interaction be immersive as well. For example, the environment the user sees changes according to his movement, as another example, when the user tries to pick up an object in the virtual environment, it seems that the object is in the use's hand

3D interaction technology needs to support a user to complete different types of tasks in a three-dimensional space, according to the supported task types, 3D interaction technology can be divided into the following techniques: selection and operation, navigation, system control, and symbol input. Selection and operation refers to that a user can specify the virtual object and operate it (such as rotating or placing it) by hand. Navigation refers to the ability of a user to change the viewpoint. System control involves user's instructions to change the system states, including graphical menus, voice commands, gesture recognition, and virtual tools with specific functions. The symbol input is that the user is allowed to input words and symbols. Immersive 3D interaction requires to solve a three-dimensional locating problem of the objects that interacts with virtual reality environments. For example, if the user is to move an object, the virtual reality system needs to identify the hands of the user and real-time track the hand location, to change the location of the object moved by the user's hand in the virtual world, and to identify gestures of the user by locating the every finger of the user to make sure whether the user can maintain holding the object. The three-dimensional locating refers to determining the spatial state of an object in a three-dimensional space, i.e. a pose, including the position and the orientation (yaw angle, pitch angle, and roll angle). The more accurate the locating is, the truer and more accurate the feedback of the virtual reality system to the user.

If the device used for locating is bound to the object to be measured, the locating problem is referred to as a self-locating problem. The movement of a user in virtual reality is the issue of self-locating. One approach to solve the self-locating problem is to measure the relative change of the pose in a certain period of time only through the inertial sensor, combine it with the initial pose and calculate the current pose by cumulative calculation. However, the inertial sensor has a certain error, the error is magnified by cumulative calculation. Therefore, the result of self-locating based on the inertial sensor is not always accurate, or the drift of the measurement result may occur. At present, head-mounted virtual reality devices can capture the posture of a user's head through the tri-axial angular velocity sensor. And the cumulative error can be eased to some extent through a geomagnetic sensor. However, such methods cannot measure the position change of head, so the user can only view the virtual world from different angles in a fixed position, and the user can not be completely immersed in the interaction. If a linear acceleration sensor is added to the head-mounted device to measure the displacement of the head, user's position in the virtual world will be deviated because of the fact that the problem of accumulative error cannot be solved, therefore, this method cannot meet the accuracy requirements of the location.

Another solution to the self-locating problem is to locate and track other static objects in the environment where the measured object is located to obtain the relative pose change of static objects to the measured object, so as to inversely calculate the absolute pose change of the measured object in the environment. In one word, the nature of the solution is to locate the object.

In the Chinese patent application CN201310407443, an immersive virtual reality system based on movement capture is disclosed, which proposes to capture the movement of the user through an inertial sensor, to constrain and correct the accumulative error caused by the inertial sensor through the biomechanics of human body, thereby achieving accurate location and tracking on the user's body. The invention mainly solves the problem of locating and tracking the posture of the body and the human body, and does not solve the problem of locating and tracking the whole body in the whole environment and the problem of locating and tracking the gesture of the user.

In the Chinese patent application CN201410143435, a virtual reality component system is disclosed, in the invention, the user interacts with a virtual environment through a controller, and the controller utilizes an inertial sensor to locate and track user's body. It cannot solve the problem that the user is not able to perform empty hand interaction in the virtual environment, neither the problem of locating the location of the human body as a whole.

Both the technical solutions of the two aforementioned patents use inertial sensor information, and such sensors have problems that internal error is relatively big and the accumulative error cannot be eliminated internally, and thus cannot satisfy the need of accurate location. In addition, solutions are not provided to solve the following problems: 1) self-locating of the user, 2) locating and tracking objects in the real scenario, thereby integrating real objects into a virtual reality.

In the Chinese patent application CN201410084341, a real scenario mapping system and method in virtual reality is disclosed. The invention discloses a system and a method for mapping a real scenario into a virtual environment, the method can capture scenario features by a real scenario sensor, and achieve the mapping from a real scenario into virtual world based on the default mapping relations. However, the invention does not provide a solution to solve the location problem in 3D interaction.

### SUMMARY OF THE INVENTION

The technical solution of the present invention uses computer stereoscopic vision technology to identify the shape of the object in the vision of the visual sensor, extract the feature thereon, and separate the scenario features and the object features, users' self-locating can be achieved by using the scenario features and real-time locating and tracking of objects can be achieved by using the object features.

According to the first aspect of the invention, there is provided the first scenario extraction method according to the first aspect of the invention, comprising: capturing a first image of a real scenario; extracting a plurality of first features from the first image, each of the plurality of the first features having a first location; capturing a second image of the real scenario, and extracting a plurality of second features from the second image, each of the plurality of second features having a second location; based on the movement information, estimating a first estimated location of each of the plurality of first features using the plurality of first locations; and selecting a second feature having a second location near the first estimated location as a scenario feature of the real scenario.

According to the first aspect of the invention, there is provided the second scenario extraction method according to the first aspect of the invention, comprising: capturing a first image of a real scenario; extracting the first feature and the second feature from the first image, the first feature having a first location and the second feature having a second location; capturing a second image of a real scenario, and extracting the third feature and the fourth feature from the second scenario, the third feature having a third location and the fourth feature having a fourth location; based on the movement information, estimating a first estimated location of the first feature and estimating a second estimated location of the second feature using the first location and the second location; if the third location being near the first estimated location, the third feature being taken as a scenario feature of the real scenario; and/or if the fourth location being near the second estimated location, the fourth feature being taken as a scenario feature of the real scenario.

According to the second scenario extraction method of the first aspect of the present invention, there is provided the third scenario extraction method according to the first aspect of the present invention, wherein the first feature and the third feature correspond to the same feature in the real scenario, and the second feature and the fourth feature correspond to the same feature in the real scenario.

According to the aforementioned scenario extraction methods of the first aspect of the present invention, there is provided the fourth scenario extraction method according to the first aspect of the present invention, wherein the step of capturing the second image of the real scenario is performed prior to the step of capturing the first image of the real scenario.

According to the aforementioned scenario extraction methods of the first aspect of the present invention, there is provided the fifth scenario extraction method according to the first aspect of the present invention, the movement information is the movement information of image capture device for capturing the real scenario, and/or the movement information is the movement information of the object in the real scenario.

According to the first aspect of the invention, there is provided the sixth scenario extraction method according to the first aspect of the invention, comprising: at the first moment, capturing a first image of a real scenario using a visual capture device; extracting a plurality of first features from the first image, each of the plurality of the first features having a first location; at the second moment, capturing a second image of a real scenario using a visual capture device; extracting a plurality of second features from the second image, each of the plurality of second features having a second location; based on the movement information of the visual capture device, estimating a first estimated location at the second moment of each of the plurality of first features using the plurality of first locations; and selecting a second feature having the second location near the first estimated location as a scenario feature of the real scenario.

According to the first aspect of the invention, there is provided the seventh scenario extraction method according to the first aspect of the invention, comprising: at the first moment, capturing a first image of a real scenario using a visual capture device; extracting the first feature and the second feature from the first image, the first feature having a first location and the second feature having a second location; at the second moment, capturing a second image of the real scenario using a visual capture device, extracting the third feature and the fourth feature from the second scenario, the third feature having a third location and the fourth feature having a fourth location; based on the movement information of the visual capture device, estimating a first estimated location at the second moment of the first feature and estimating a second estimated location at the second moment of the second feature using the first location and the second location; If the third location being near the first estimated location, the third feature being taken as a scenario feature of the real scenario; and/or if the fourth location being near the second estimated location, the fourth feature being taken as a scenario feature of the real scenario.

According to the seventh scenario extraction method of the first aspect of the present invention, there is provided the eighth scenario extraction method according to the first aspect of the present invention, wherein the first feature and the third feature correspond to the same feature in the real scenario, and the second feature and the fourth feature correspond to the same feature in the real scenario.

According to the second aspect of the invention, there is provided the first object locating method according to the second aspect of the invention, comprising: acquiring a first pose of the first object in the real scenario; capturing a first image of the real scenario; extracting a plurality of first features from the first image, each of the plurality of first features having a first location; capturing a second image of the real scenario; extracting a plurality of second features from the second image, each of the plurality of second features having a second location; based on the movement information, estimating a first estimated location of each of the plurality of first features using the plurality of first locations; selecting a second feature having the second location near the first estimated location as a scenario feature of the real scenario; and obtaining the second pose of the first object using the scenario feature.

According to the second aspect of the invention, there is provided the second object locating method according to the second aspect of the invention, comprising: acquiring a first pose of the first object in the real scenario; capturing a first image of a real scenario; extracting the first feature and the second feature from the first image, the first feature having a first location and the second feature having a second location; capturing a second image of the real scenario, and extracting the third feature and the fourth feature from the second image, the third feature having a third location and the fourth feature having a fourth location; based on the movement information, estimating a first estimated location of the first feature, estimating a second estimated location of the second feature using the first location and the second location; If the third location being near the first estimated location, the third feature being taken as a scenario feature of the real scenario; and/or if the fourth location being near the second estimated location, the fourth feature being taken as a scenario feature of the real scenario, and obtaining a second pose of the first object using the scenario feature.

According to the second object locating method of the second aspect of the invention, there is provided a third object locating method according to the second aspect of the invention, wherein the first feature and the third feature correspond to the same feature in the real scenario, and the second feature and the fourth feature correspond to the same feature in the real scenario.

According to the aforementioned object locating method of the second aspect of the invention, a fourth object locating method according to the second aspect of the invention is provided, wherein the step of capturing the second image of the real scenario is performed prior to the step of capturing the first image of the real scenario.

According to the aforementioned object locating method of the second aspect of the present invention, there is provided a fifth object locating method according to the second aspect of the invention, wherein the movement information is the movement information of the first object.

According to the aforementioned object locating method according to the second aspect of the present invention, there is provided a sixth object locating method according to the second aspect of the present invention, further comprising acquiring an initial pose of the first object in the real scenario; and obtaining a first pose of the first object in the real scenario based on the initial pose and the movement information of the first object obtained by the sensor.

According to the sixth object locating method of the second aspect of the invention, there is provided a seventh object locating method according to the second aspect of the invention, wherein the sensor is located at the location of the first object.

According to the aforementioned object locating method of the second aspect of the present invention, there is provided an eighth object locating method according to the second aspect of the invention, wherein the visual capture device is located at the location of the first object.

According to the aforementioned object locating method according to the second aspect of the present invention, there is provided a ninth object locating method according to the second aspect of the present invention, further comprising determining a pose of the scenario feature based on the first pose and the the scenario feature, and determining a second pose of the first object using the scenario feature, including: obtaining a second pose of the first object in the real scenario based on the pose of the scenario feature.

According to the third aspect of the invention, there is provided a first object locating method according to the third aspect of the invention, comprising: obtaining the first pose of the first object in the real scenario based on the movement information of the first object; capturing the first image of the real scenario; extracting a plurality of first features from the first image, each of the first plurality of the features having a first location; capturing a second image of the real scenario; extracting a plurality of second features from the second image, each of the second plurality of the features having a second location; based on the movement information of the first object, estimating a first estimated location of each of the plurality of first features using the plurality of first locations; selecting a second feature having a second location near the first estimated location as a scenario feature of the real scenario; and obtaining the second pose of the first object using the scenario feature.

According to the third aspect of the present invention, there is provided a second object locating method according to the third aspect of the invention comprising: obtaining the first pose of the first object in the real scenario based on the movement information of the first object; at a first moment, capturing the first image of the real scenario using a visual capture device; extracting the first feature and the second feature from the first image, the first feature having a first location and the second feature having a second location; at a second moment, capturing the second image of the real scenario using a visual capture device; extracting the third feature and the fourth feature from the second image, the third feature having a third location and the fourth feature having a second location; based on the movement information of the first object, using the first location and the second location, estimating a first estimated location at the second moment of the first feature, estimating a second estimated location at the second moment of the second feature; If the third location being near the first estimated location, the third feature being taken as a scenario feature of the real scenario; and/or if the fourth location being near the second estimated location, the fourth feature being taken as a scenario feature of the real scenario, and determining the second pose of the first object at the second moment using the scenario feature.

According to the second object locating method of the third aspect of the present invention, there is provided a third object locating method according to the third aspect of the invention, wherein the first feature and the third feature correspond to the same feature in the real scenario, and the second feature and the fourth feature correspond to the same feature in the real scenario.

According to the aforementioned object locating method of the third aspect of the invention, there is provided a fourth object locating method according to the third aspect of the invention, further comprising acquiring an initial pose of the first object in the real scenario; and obtaining a first pose of the first object in the real scenario based on the initial pose and the movement information of the first object obtained by the sensor.

According to the fourth object locating method of the third aspect of the present invention, there is provided a fifth object locating method according to the third aspect of the invention, wherein the sensor is located at the location of the first object.

According to the aforementioned object locating method of the third aspect of the present invention, there is provided a sixth object locating method according to the third aspect of the present invention, wherein the visual capture device is located at the location of the first object.

According to the sixth object locating method of the third aspect of the present invention, there is provided a seventh object locating method according to the third aspect of the present invention, further comprising determining the pose of the scenario feature based on the first pose and the scenario feature, and determining the second pose of the first object at the second moment based on the scenario feature including: obtaining the second pose of the second object at the second moment in the real scenario based on the pose of the scenario feature.

According to the fourth aspect of the invention, there is provided a first object locating method according to the fourth aspect of the invention, comprising: obtaining the first pose of the first object in the real scenario based on the movement information of the first object; capturing a second image of the real scenario; obtaining the pose distribution of the first object in the real scenario based on the movement information and through the first pose, obtaining a first possible pose and a second possible pose of the first object in the real scenario from the pose distribution of the first object in the real scenario; respectively evaluating the first possible pose and the second possible pose based on the second image, to generate a first weighted value for the first possible pose and a second weighted value for the second possible pose; calculating a weighted average of the first possible pose and the second possible pose based on the first weighted value and the second weighted value as the pose of the first object.

According to the first object locating method of the fourth aspect of the invention, there is provided the second object locating method according to the fourth aspect of the invention, wherein respectively evaluating the first possible pose and the second possible pose based on the second image, comprising: respectively evaluating the first possible pose and the second possible pose based on the scenario feature extracted from the second imag.

According to the second object locating method of the fourth aspect of the invention, there is provided the third object locating method according to the fourth aspect of the invention, further comprising: capturing the first image of the real scenario; extracting a plurality of first features from the first image, each of the plurality of the first features having a first location; based on movement information, estimating a first estimated location of each of the plurality of first features; wherein capturing the second image in the real scenario includes extracting a plurality of second features from the second image, and a second location of each of the plurality of second features; selecting a second feature having a second location near the first estimated location as a scenario feature of the real scenario.

According to the aforementioned object locating method of the fourth aspect of the invention, there is provided the fourth object locating method according to the fourth aspect of the invention, further comprising acquiring an initial pose of the first object in the real scenario; and obtaining a first pose of the first object in the real scenario, based on the initial pose and the movement information of the first object obtained by the sensor.

According to the fourth object locating method of the fourth aspect of the invention, there is provided a fifth object locating method according to the fourth aspect of the invention, wherein the sensor is located at the location of the first object.

According to the fourth aspect of the invention, there is provided the sixth object locating method according to the fourth aspect of the invention, comprising: obtaining a first pose of the first object at a first moment in the real scenario; at a second time, capturing the second image of the real scenario using a visual capture device; based on the movement information of the visual capture device, through the first pose, obtaining the pose distribution of the first object at the second moment, and obtaining a first possible pose and a second possible pose of the first object in the real scenario from the distribution of the first object in the real scenario at the second moment; respectively evaluating the first possible pose and the second possible pose based on the second image, to generate a first weighted value for the first possible pose and a second weighted value for the second possible pose; and based on the first weighted value and the second weighted value, calculating a weighted average of the first possible pose and the second possible pose as the pose of the first object at the second moment.

According to the sixth object locating method of the fourth aspect of the invention, there is provided a seventh object locating method according to the fourth aspect of the invention, wherein respectively evaluating the first possible pose and the second possible pose based on the second image, comprising: respectively evaluating the first possible pose and the second possible pose based on the scenario feature extracted from the second image.

According to the seventh object locating method of the fourth aspect of the invention, the eighth object locating method according to the fourth aspect of the invention is provided. It further comprises: capturing a first image of the real scenario with a visual acquisition device; extracting the first feature and the second feature in the first image, the first feature having a first location, the second feature having a second location; the third feature and the fourth feature in the second image are extracte, the third feature having a third location, the fourth feature having a fourth location; estimating a first estimated location of the first feature at the second moment using the first location and the second location based on the motion information of the first object, and estimating a second estimated location of the second feature at the second moment; if the third location is located near the first estimated location, the third feature is used as a scenario feature of the real scenario; and/or if the fourth location is located near the second estimated location, the fourth feature is used as a scenario feature of the real scenario.

According to the eighth object locating method of the fourth aspect of the invention, the ninth object locating method according to the fourth aspect of the invention is provided, wherein the first feature and the third feature correspond to the same feature in the real scenario, and the second feature and the fourth feature correspond to the same feature in the real scenario.

According to the sixth to ninth object locating method of the fourth aspect of the invention, there is provided the tenth object locating method according to the fourth aspect of the invention. It further comprises obtaining an initial pose of the first object in the real scenario, and obtaining a first pose of the first object in the real scenario, based on the initial pose and the motion information of the first object obtained by the sensor.

According to the tenth object locating method of the fourth aspect of the invention, the eleventh object locating method according to the fourth aspect of the invention is provided, wherein the sensor is located at the location of the first object.

According to the fifth aspect of the invention, there is provided the first object locating method according to the fifth aspect of the present invention, comprising: obtaining the first pose of the first object in the real scenario according to the motion information of the first object; capturing the first image of the real scenario; extracting a plurality of first features in the first image, each of the plurality of first features having a first location; capturing a second image of the real scenario, extracting a plurality of second features in the second scenario, each of the plurality of second features has a second location; estimating a first estimated location of each of the plurality of first features based on the motion information of the first object using the plurality of first locations; the second feature of the second location located near the first estimated location is selected as the scenario feature of the real scenario; the second pose of the first object is determined using the scenario feature; and obtaining the pose of the second object based on the second pose and the pose of the second object relative to the first object in the second image.

According to the first object locating method of the fifth aspect of the present invention, the second object locating method according to the fifth aspect of the present invention is provided, further comprising selecting a second feature of the second location not located near the first estimated location, as the feature of the second object.

According to the aforementioned object locating method of the fifth aspect of the invention, there is provided the third object locating method according to the fifth aspect of the present invention, wherein the step of capturing the second image of the real scenario is performed prior to the step of capturing the first image of the real scenario.

According to the aforementioned object locating method of the fifth aspect of the invention, the fourth object locating method is provided according to the fifth aspect of the invention, wherein the motion information is the motion information of the first object.

According to the aforementioned object locating method of the fifth aspect of the invention, there is provided the fifth object locating method according to the fifth aspect of the invention, and it further comprises obtaining an initial pose of the first object in the real scenario, and obtaining a first pose of the first object in the real scenario based on the initial pose and the motion information of the first object obtained by the sensor.

According to the fifth object locating method of the fifth aspect of the present invention, the sixth object locating method according to the fifth aspect of the invention is provided, wherein the sensor is located at the location of the first object.

According to the aforementioned object locating method according to the fifth aspect of the invention, there is provided the seventh object locating method according to the fifth aspect of the invention, further comprising determining the pose of the scenario feature according to the first pose and the scenario feature, and determining the second pose of the first object by using the scenario feature comprises: obtaining a second pose of the first object according to the pose of the scenario feature.

According to the fifth aspect of the invention, the eighth object locating method according to the fifth aspect of the invention is provided, comprising: obtaining a first pose of the first object in the real scenario at the first moment; at the second moment, capturing a second image in the real scenario using the visual capture device; based on the motion information of the visual capture device, the pose distribution of the first object in the real scenario is obtained by the first pose, obtaining a first possible pose and a second possible pose of the first object in the real scenario from a pose distribution of the first object in a real scenario; the first possible pose and the second possible pose are respectively evaluated based on the second image, to generate a first weighted value for the first possible pose and a second weighted value for the second possible pose; calculating a weighted average of the first possible pose and the second possible pose based on the first weighted value and the second weighted value, as a second pose of the first object at the second moment; obtaining the pose of the second object based on the second pose and the pose of the second object relative to the first object in the second image.

According to the eighth object locating method of the fifth aspect of the invention, there is provided the ninth object locating method according to the fifth aspect of the present invention, wherein the first possible pose and the second possible pose are respectively evaluated based on the second image, comprising respectively evaluating the first possible pose and the second possible pose, respectively, based on the scenario feature extracted from the second image.

According to the ninth object locating method of the fifth aspect of the invention, the tenth object locating method according to the fifth aspect is provided, further comprising: capturing the first image of the real scenario using a visual capture device, extracting the first feature and the second feature in the first image, the first feature having a first location, the second feature having a second location; extracting the third feature and the fourth feature in the second image, the third feature having a third location, the fourth feature having a fourth location; based on the motion information of the first object, using the first location and the second location to estimate a first estimated location of the first feature at the second moment, estimate a second estimated location of the second feature at the second moment; if the third location is located near the first estimated location, the third feature is used as a scenario feature of the real scenario; and/or if the fourth location is located near the second estimated location, the fourth feature is used as a scenario feature of the real scenario.

According to the tenth object locating method of the fifth aspect of the invention, there is provided the eleventh object locating method according to the fifth aspect of the invention, wherein the first feature and the third feature correspond to the same feature in the real scenario, and the second feature and the fourth feature correspond to the same feature in the real scenario.

According to the eighth to the eleventh object locating method of the fifth aspect of the invention, there is provided the twelfth object locating method according to the fifth aspect of the invention, further comprising obtaining an initial pose of the first object in the real scenario; and obtaining a first pose of the first object in the real scenario, based on the initial pose and the motion information of the first object obtained by the sensor.

According to the twelfth object locating method of the fifth aspect of the invention, the thirteenth object locating method according to the fifth aspect of the invention is provided, wherein the sensor is located at the location of the first object.

According to the sixth aspect of the invention, a first virtual scenario generation method according to the sixth aspect of the invention is provided, comprising: obtaining the first pose of the first object in the real scenario based on the motion information of the first object; capturing the first image of the real scenario; extracting a plurality of first features in the first image, each of plurality of first features having a first location; capturing a second image of the real scenario, and extracting a plurality of second features in the second scenario, each of the plurality of second features having a second location; based on the motion information of the first object, estimating the first estimated location of each of the plurality of the first features at the second time using the plurality of first locations, selecting a second feature of the second location near the first estimated location as a scenario feature of the real scenario, and determining a second pose of the first object at a second moment using the scenario feature; and obtaining an absolute pose of the second object at a second moment based on the second pose and the pose of the second object relative to the first object in the second image; and generating a virtual scenario containing the real scenario of the second object based on the absolute pose of the second object in the real scenario.

According to the first virtual scenario generation method of the sixth aspect of the invention, the second virtual scenario generation method according to the sixth aspect of the invention is provided, further comprising selecting a second feature of the second location that is not located near the first estimated location as a feature of the second object.

According to the aforementioned virtual scenario generation method of the sixth aspect of the invention, the third virtual scenario generation method according to the sixth aspect of the invention is provided, wherein the step of capturing the second image of the real scenario is performed prior to the step of capturing the first image of the real scenario.

According to the aforementioned virtual scenario generation method of the sixth aspect of the invention, the fourth virtual scenario generation method according to the sixth aspect of the invention is provided, wherein the motion information is the motion information of the first object.

According to the aforementioned virtual scenario generation method of the sixth aspect of the invention, the fifth virtual scenario generation method according to the sixth aspect of the invention is provided, further comprising obtaining an initial pose of the first object in the real scenario; and obtaining a first pose of the first object in the real scenario based on the initial pose and the motion information of the first object obtained by the sensor.

According to the fifth virtual scenario generation method of the sixth aspect of the invention, the sixth virtual scenario generation method according to the sixth aspect of the invention is provided, wherein the sensor is located at the location of the first object.

According to the aforementioned virtual scenario generation method of the sixth aspect of the invention, the seventh virtual scenario generation method according to the sixth aspect of the invention is provided, further comprising determining the pose of the scenario feature according to the first pose and the scenario feature, and determining the second pose of the first object using the scenario feature comprises obtaining the second pose of the first object according to the pose of the scenario feature.

According to the sixth aspect of the invention, the eighth virtual scenario generation method according to the sixth aspect of the invention is provided, comprising obtaining the first pose of the first object in the real scenario at the first moment; capturing a second image of the real scenario with a visual capture device at a second moment; based on the motion information of the visual capture device, the pose distribution of the first object in the real scenario is obtained by the first pose, obtaining the first possible pose and the second possible pose of the first object in the real scenario from the pose distribution of the first object in the real scenario; evaluating the first possible pose and the second possible pose respectively based on the second image, to generate a first weighted value for the first possible pose, and a second weighted value for the second possible pose; calculating a weighted average of the first possible pose and the second possible pose based on the first weight value and the second weight value, as a second pose of the first object at the second moment; based on the second pose, and the pose of the second object relative to the first object in the second image, the absolute pose of the second object in the real scenario is obtained; based on the absolute pose of the second object in the real scenario, a virtual scene containing the real scenario of the second object is generated.

According to the eighth virtual scenario generation method of the sixth aspect of the invention, the ninth virtual scenario generation method according to the sixth aspect of the invention is provided, wherein the first possible pose and the second possible pose are respectively evaluated based on the second image, comprising: respectively evaluating the first possible pose and the second possible pose based on the scene features extracted from the second image.

According to the ninth virtual scenario generation method of the sixth aspect of the invention, the tenth virtual scenario generation method according to the sixth aspect of the invention is provided, further comprising: capturing the first image of the real scenario using a visual capture device; extracting the first feature and the second feature in the first image, the first feature having a first location, the second feature having a second location; extracting the third feature and the fourth feature in the second image; the third feature having a third location, the fourth feature having a fourth location; estimating a first estimated location of the first feature at the second moment using the first location and the second location based on the motion information of the first object, estimating a second estimated location of the second feature at the second moment; if the third location is located near the first estimated location, the third feature is used as a scenario feature of the real scenario; and/or if the fourth location is located near the second estimated location, the fourth feature is used as a scenario feature of the real scenario.

According to the tenth virtual scenario generation method of the sixth aspect of the invention, there is provided the eleventh virtual scenario generation method according to the sixth aspect of the invention, wherein the first feature and the third feature correspond to the same feature in the real scenario, and the second feature and the fourth feature correspond to the same feature in the real scenario.

According to the eighth to the eleventh virtual scenario generation method of the sixth aspect of the invention, the twelfth virtual scenario generation method according to the sixth aspect of the invention is provided, further comprising obtaining an initial pose of the first object in the real scenario; and obtaining a first pose of the first object in the real scenario based on the initial pose and the motion information of the first object obtained by the sensor.

According to the eighth to the twelfth virtual scenario generation method of the sixth aspect of the invention, the thirteenth virtual scenario generation method of the sixth aspect of the invention is provided, wherein the sensor is located at the location of the first object.

According to the seventh aspect of the invention, a method of locating an object based on visual perception is provided, comprising: obtaining the initial pose of the first object in the real scenario; and obtaining the pose of the first object in the real scenario at the first moment based on the initial pose and the motion variation information of the first object obtained by the sensor at the first moment.

According to the seventh aspect of the invention, a computer is provided, comprising a machine-readable storage for storing program instructions, one or more processors for executing program instructions stored in the memory; the program instructions for causing the one or more processors to perform one of many methods provided in accordance with the first to sixth aspects of the invention.

According to the eighth aspect of the invention, there is provided a program that enables a computer to perform one of a variety of methods provided in accordance with the first to sixth aspect of the invention.

In accordance with the ninth aspect of the present invention, there is provided a computer-readable storage medium having a program recorded thereon, wherein the program causes a computer to perform one of a plurality of methods provided in accordance with the first to sixth aspect of the invention.

According to the tenth aspect of the invention, a scenario extraction system is provided, including: a first capture module for capturing a first image of a real scenario; an extraction module for extracting a plurality of first features in the first image, each of the plurality of the first features having a first location; a second capture module for capturing a second image of the real scenario, extracting a plurality of second features in the second scenario; each of the plurality of second features having a second location; the location estimation module for estimating a first estimated location of each of the plurality of first features using the plurality of first locations based on motion information; a scenario feature extraction module for selecting a second feature of a second location located near a first estimated location as a scenario feature of the real scenario.

According to the tenth aspect of the invention, the scenario extraction system is provided, comprising a first capture module for capturing a first image of a real scenario, a feature extraction module for extracting a first feature and a second feature in the first image, the first feature having a first location, the second feature having a second location; a second capture module for capturing a second image of the real scenario, extracting a third feature and a fourth feature in the second scene; the third feature having a third location, the fourth feature having a fourth location; the location estimation module for estimating a first estimated location of the first feature, and estimating the second estimated location of the second feature based on motion information and using the first location and the second location; a scenario feature extraction module, for using the third feature as a scenario feature of the real scenario if the third location is located near the first estimated location, and/or if the fourth location is located near the second estimated location, using the fourth feature as a scenario feature of the real scenario.

According to the tenth aspect of the invention, a scenario extraction system is provided, comprising: the first capture module for capturing the first image of the real scenario using the visual capture device at the first moment; a feature extraction module for extracting a plurality of first features in the first image, each of a plurality of first features having a first location; a second capturing module, for capturing a second image of the real scenario using a visual capture device at the second moment to extract a plurality of second features in the second scenario; each of the plurality of second features having a second location; a location estimation module for estimating a first estimated location for each of the plurality of first features at the second moment, based on the motion information of the visual capture device using the plurality of first locations; a scenario feature extraction module for selecting a second feature of a second location located near a first estimated location as a scenario feature of the real scenario.

According to the tenth aspect of the invention, a scenario extraction system is provided, comprising: the first capture module for capturing the first image of the real scenario using the visual capture device at the first moment; the feature extraction module for extracting a first feature and a second feature in the first image, the first feature having a first location, the second feature having a second location; a second capturing module, for capturing a second image of the real scenario by using a visual capture device at a second moment to extract a third feature and a fourth feature in the second scenario; the third feature having a third location, the fourth feature having a fourth location; a location estimation module for estimating a first estimated location of the first feature, using the first location and the second location based on the motion information, and estimating the second estimated location of the second feature; a scenario feature extraction module, for using the third feature as a scenario feature of the real scenario if the third location is located near the first estimated location; and/or if the fourth location is located near the second estimated location, using the fourth feature as a scenario feature of the real scenario.

According to the tenth aspect of the invention, a scenario extraction system is provided, comprising: the first capture module for capturing the first image of the real scenario using the visual capture device at the first moment; the feature extraction module for extracting a plurality of the first features in the first image, each of the plurality of the first features having a first location; the second capture module for capturing the second image of the real scenario using the visual capture device at the second moment, to extract a plurality of the second features in the second image, each of the plurality of the second features having a second location; a location estimation module for estimating a first estimated location of each of the plurality of the first features at the second moment, using the plurality of the first locations based on the motion information of the visual capture device; a scenario feature extraction module, for selecting the second feature of the second location located near the first estimated location as a scenario feature of the real scenario.

According to the tenth aspect of the invention, a scenario extraction system is provided, comprising: the first capture module for capturing the first image of the real scenario using the visual capture device at the first moment; the feature extraction module for extracting the first feature and the second feature in the first image, the first feature having a first location, the second feature having a second location; the second capture module for capturing the second image of the real scenario using the visual capture device at the second moment, to extract the third feature and the fourth feature in the second image, the third feature having a third location, the fourth feature having a fourth location; a location estimation module for estimating a first estimated location of the first feature at the second moment, using the first location and the second location based on the motion information of the visual capture device, estimating a second estimated location of the second feature at the second moment; a scenario feature extraction module, for using the third feature as a scenario feature of the real scenario if the third location is located near the first estimated location; and/or if the fourth location is located near the second estimated location, using the fourth feature as a scenario feature of the real scenario.

According to the tenth aspect of the invention, there is provided a object locating system comprising: the pose acquisition module for acquiring the first pose of the first object in the real scenario; the first capture module for capturing a first image of a real scenario; the feature extraction module for extracting a plurality of first features in the first image, each of the plurality of first features having a first location; the second capture module for capturing a second image of the real scenario, extracting a plurality of second features in the second scenario; each of the plurality of second features having a second location; the location estimation module for estimating a first estimated location of each of the plurality of first features using the plurality of first locations based on motion information; the scenario feature extraction module for selecting a second feature of a second location located near a first estimated location as a scenario feature of the real scenario; and the locating module for obtaining a second pose of the first object using the scenario feature.

According to the tenth aspect of the invention, there is provided a object locating system comprising: a pose acquisition module for acquiring the first pose of the first object in the real scenario; a first capture module for capturing a first image of a real scenario; a feature extraction module for extracting a first feature and second feature in the first image, the first feature having a first location, the second feature having a second location; a second capture module for capturing a second image of the real scenario, extracting the third feature and the fourth feature in the second scenario; the third feature having a third location, the fourth feature having a fourth location; the location estimation module for estimating a first estimated location of the first feature, estimating a second estimated location of the second feature using the first location and the second location based on motion information; a scenario feature extraction module, for using the third feature as a scenario feature of the real scenario if the third location is located near the first estimated location; and/or if the fourth location is located near the second estimated location, using the fourth feature as a scenario feature of the real scenario; and a locating module, for obtaining the second pose of the first object using the scenario feature.

According to the tenth aspect of the invention, there is provided a object locating system comprising: a pose acquisition module for obtaining a first pose of the first object in the real scenario based on motion information of the first object; a first capture module for capturing a first image of the real scenario; a location feature extraction module for extracting a plurality of first features in the first image, each of a plurality of first features having a first location; a second capture module for capturing a second image of the real scenario, extracting a plurality of second features in the second scenario; each of the plurality of second feature having a second location; the location estimation module for estimating a first estimated location of each of the plurality of the first features using the plurality of first locations based on the motion information of the first object; a scenario feature extraction module for selecting a second feature of the second location near a first estimated location as a scenario feature of the real scenario, and a locating module for obtaining a second pose of the first object using the scenario feature.

According to the tenth aspect of the invention, there is provided a object locating system comprising: a pose acquisition module for obtaining a first pose of the first object in the real scenario based on motion information of the first object; a first capture module for capturing a first image of the real scenario using a visual capture device at a first moment; a location feature extraction module for extracting a first feature and a second feature in the first image, the first feature having a first location, the second feature having a second location; a second capture module for capturing the second image of the real scenario using the visual capture device at a second moment, extracting a third feature and a fourth feature in the second scenario; the third feature having a third location, the fourth feature having a fourth location; the location estimation module for estimating a first estimated location of the first feature at the second moment, estimating a second estimated location of the second feature at the second moment based on the motion information of the first object using the first location and the second location; a scenario feature extraction module, for using the third feature as a scenario feature of the real scenario if the third location is located near the first estimated location; and/or if the fourth location is located near the second estimated location, using the fourth feature as a scenario feature of the real scenario, and a locating module for determining a second pose of the first object at a second moment using the scenario feature.

According to the tenth aspect of the invention, there is provided a object locating system comprising: a pose acquisition module for obtaining a first pose of the first object in the real scenario based on motion information of the first object; an image capture module for capturing a second image of a real scenario; a pose distribution determination module for obtaining a pose distribution of the first object in real scenario using the first pose based on the motion information, a pose estimation module for obtaining the first possible pose and the second possible pose of the first object in the real scenario from the pose distribution of the first object in the real scenario; the weight generation module for respectively evaluating the first possible pose and the second possible pose based on the second image to generate first weighted value for the first possible pose, and second weighted value for the second possible pose; a pose calculation module for calculating a weighted average of the first possible pose and the second possible pose based on the first weighted value and the second weighted value as a pose of the first object.

According to the tenth aspect of the invention, there is provided an object locating system comprising: a pose acquisition module for obtaining a first pose of a first object in a real scenario at a first moment; an image capture module for capturing a second image of the real scenario with a vision capture device at a second moment; a pose distribution determining module, for obtaining the pose distribution of the first object in the real scenario at the second moment by using the first pose based on the movement information of the visual capture device; a pose estimation module for obtaining the first possible pose and the second possible pose of the first object in the real scenario from the pose distribution of the first object in the real scenario at the second moment; a weight generation module for respectively evaluating the first possible pose and the second possible pose based on the second image to generate first weighted value for the first possible pose and second weighted value for the second possible pose; a pose determining module for calculating a weighted average of the first possible pose and the second possible pose based on the first weighted value and the second weighted value as the pose of the first object at the second moment.

According to the tenth aspect of the invention, there is provided an object locating system comprising: a pose acquisition module for obtaining a first pose of a first object in a real scenario based on the movement information of the first object; a first capture module for capturing the first image of the real scenario; a location determining module for extracting a plurality of first features in the first image, each of the plurality of first features having a first location; a second capture module for capturing the second image of the real scenario, extracting a plurality of second features in the second scenario; each of the plurality of second features having a second location; a location estimation module for estimating a first estimated location of each of the plurality of first features using the plurality of first locations based on the movement information of the first object; a scenario feature extraction module for selecting a second feature of the second location near the first estimated location as the scenario feature of the real scenario; a pose determination module for determining a second pose of the first object using the scenario features; and a pose calculation module for obtaining the pose of the second object based on the second pose and the pose of the second object relative to the first object in the second image.

According to the tenth aspect of the invention, there is provided an object locating system comprising: a pose acquisition module for obtaining a first pose of a first object in a real scenario at a first moment; a first capture module, for capturing a second image of a real scenario using the visual acquisition device at a second moment; a pose distribution determining module, for obtaining the pose distribution of the first object in the real scenario using the first pose based on the movement information of the visual capture device; a pose estimation module for obtaining the first possible pose and the second possible pose of the first object in the real scenario from the pose distribution of the first object in the real scenario; a weight generation module for evaluating respectively the first possible pose and the second possible pose based on the second image to generate first weighted value for the first possible pose and second weighted value for the second possible pose; a pose determining module for calculating a weighted average of the first possible pose and the second possible pose based on the first weighted value and the second weighted value as the second pose of the first object at the second moment; a pose calculation module for obtaining the pose of the second object based on the second pose and the pose of the second object relative to the first object in the second image.

According to the tenth aspect of the invention, there is provided a virtual scenario generation system comprising: a pose acquisition module for obtaining a first pose of a first object in a real scenario based on the movement information of the first object; a first capture module for capturing the first image of the real scenario; a location feature extraction module for extracting a plurality of first features in the first image, each of the plurality of first features having a first location; a second capture module for capturing the second image of the real scenario and extracting a plurality of second features in the second scenario, each of the plurality of second features having a second location; a location estimation module for estimating a first estimated location of each of the plurality of first features at the second moment using the plurality of first locations based on the movement information of the first object; a scenario feature extraction module for selecting a second feature having a second location near the first estimated location as the scenario feature of the real scenario; a pose determination module for determining a second pose of the first object at a second moment using the scenario features; a pose calculation module for obtaining the absolute pose of the second object based on the second pose and the pose of the second object relative to the first object in the second image; and a scenario generation module for generating a virtual scenario containing the real scenario of the second object based on the absolute pose of the second object in the real scenario.

According to the tenth aspect of the invention, there is provided a virtual scenario generation system comprising: a pose acquisition module for obtaining a first pose of the first object in a real scenario at a first moment; a first capture module for capturing a second image of the real scenario using a visual acquisition device at a second moment; a pose distribution determining module for obtaining the pose distribution of the first object in the real scenario using the first pose based on the movement information of the visual capture device; a pose estimation module for obtaining the first possible pose and the second possible pose of the first object in the real scenario from the pose distribution of the first object in the real scenario; a weight generation module for respectively evaluating the first possible pose and the second possible pose based on the second image to generate first weighted value for the first possible pose and second weighted value for the second possible pose; a pose determining module for calculating a weighted average of the first possible pose and the second possible pose based on the first weighted value and the second weighted value as the second pose of the first object at the second moment; a pose calculation module for obtaining the absolute pose of the second object in the real scenario based on the second pose and the pose of the second object relative to the first object in the second image; a scenario generation module for generating a virtual scenario containing the real scenario of the second object based on the absolute pose of the second object in the real scenario.

According to the tenth aspect of the invention, there is provided an object locating system based on visual perception comprising: a pose acquisition module for obtaining an initial pose of a first object in a real scenario; and a pose calculation module for obtaining the pose of the first object in the real scenario at the first moment based on the initial pose and the motion variation information of the first object at the first moment obtained by the sensor.

### BRIEF DESCRIPTION OF DRAWINGS

The invention, together with a preferred mode of use and further objects and advantages thereof, will be best understood by reference to the following detailed description of the illustrative embodiments when read in conjunction with the accompanying drawings, in which:

FIG. 1 illustrates a virtual reality system according to an embodiment of the invention;

FIG. 2 is a schematic diagram of a virtual reality system according to an embodiment of the invention;

FIG. 3 is a schematic diagram showing the scenario feature extraction according to an embodiment of the invention;

FIG. 4 is a flow chart of a scenario feature extraction method according to an embodiment of the invention;

FIG. 5 is a schematic diagram of object locating of a virtual reality system according to an embodiment of the invention;

FIG. 6 is a flow chart of an object locating method according to an embodiment of the invention;

FIG. 7 is a schematic diagram of an object locating method according to another embodiment of the invention;

FIG. 8 is a flow chart of an object locating method according to another embodiment of the invention;

FIG. 9 is a flow chart of an object locating method according to still another embodiment of the invention;

FIG. 10 is a schematic diagram of feature extraction and object locating according to an embodiment of the invention;

FIG. 11 is a schematic diagram of an application scenario of a virtual reality system according to an embodiment of the invention; and

FIG. 12 is a schematic diagram of an application scenario of a virtual reality system according to another embodiment of the invention.

### DETAILED DESCRIPTION

FIG. 1 illustrates the organization of a virtual reality system 100 according to an embodiment of the invention. As shown in FIG. 1, a virtual reality system 100 according to an embodiment of the invention may be worn on the head by a user. As the user walks around and turns around indoors, the virtual reality system 100 may detect a change in the pose of the user's head to change the corresponding rendered scenario. When the user reaches out hands, the virtual reality system 100 also renders virtual hands according to the current pose of the hands, and enables the user to manipulate other objects in the virtual environment to perform three-dimensional interaction with the virtual reality environment. The virtual reality system 100 may also identify other moving objects in the scenario and locate and track them. The virtual reality system 100 includes a stereoscopic display device 110, a visual perception device 120, a visual processing device 160, and a scenario generation device 150. Optionally, the stereoscopic sound output device 140 and the auxiliary light emitting device 130 may also be included in the virtual reality system according to the embodiment of the invention. The auxiliary light emitting device 130 is used for assisting visual positioning. For example, the auxiliary light emitting device 130 may emit infrared light for providing illumination for the field of view observed by the visual perception device 120 to facilitate the image acquisition of the visual perception device 120.

Various devices in the virtual reality system according to embodiments of the invention may exchange data/control signals in a wired/wireless manner. The stereoscopic display device 110 may be, but not limited to, a liquid crystal panel, a projection device, and the like. The stereoscopic display device 110 is used to project the rendered virtual image to a person's dual eyes respectively to form a stereoscopic image. The visual perception device 120 may include a camera, lens, a depth vision sensor, and/or an inertial sensor set (tri-axial angular velocity sensor, tri-axial acceleration sensor, tri-axial geomagnetic sensor, etc.). The visual perception device 120 is used to capture the image of the surrounding environment and the object in real time and/or measure the movement status of the visual perception device. The visual perception device 120 may be fixed on the user's head and maintain a fixed relative posture with the user's head. Therefore, if the pose of the visual perception device 120 is obtained, the pose of the user's head can be calculated. The stereophonic sound device 140 is used to generate sound effects in the virtual environment. The visual processing device 160 is used for processing and analyzing the captured image, self-locating the user's head, and locating and tracking the moving objects in the environment. The scenario generation device 150 is used to update the scenario information according to the current head gesture of the user and the locating and tracking of the moving object, and also predict the image information to be captured according to the inertial sensor information, and render the corresponding virtual image in real time.

The visual processing device 160 and the scenario generation device 150 may be implemented by software running on a computer processor, an FPGA (Field Programmable Gate Array), or an ASIC (Application Specific Integrated Circuit). The visual processing device 160 and the scenario generation device 150 may be embedded in a portable device or may be located on a host or a server away from the user's portable device and communicate with the user's portable device in a wired or wireless manner. The visual processing device 160 and the scenario generation device 150 may be implemented by a single hardware device, or distributed on different computing devices and implemented by a homogeneous and/or heterogeneous computing device.

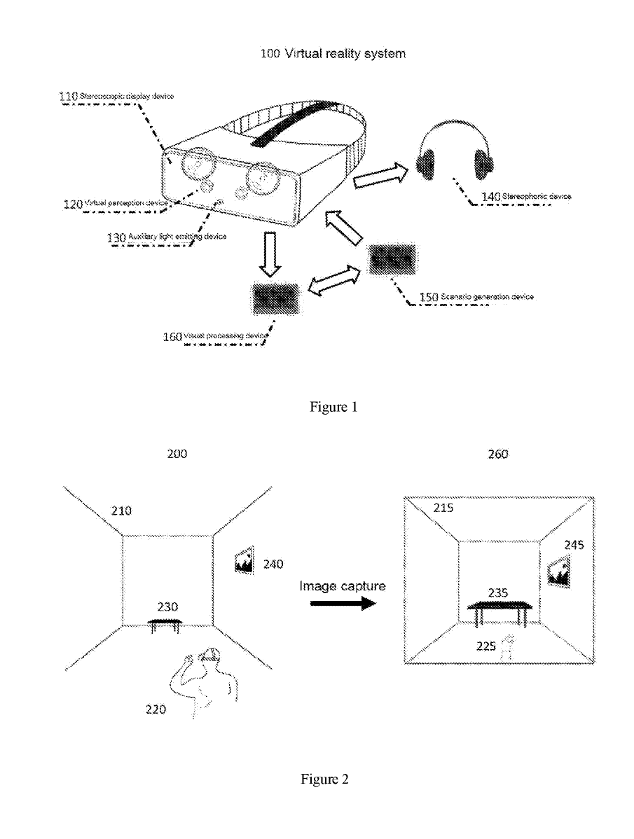

FIG. 2 is a schematic diagram of a virtual reality system according to an embodiment of the invention. FIG. 2 illustrates an application environment 200 of the virtual reality system 100 and a scenario image 260 captured by the visual perception device 120 (see FIG. 1) of the virtual reality system.

In the application environment 200, a real scenario 210 is included. The real scenario 210 may be in a building or any scenario that is stationary relative to the user or virtual reality system 100. The real scenario 210 includes a variety of objects or objects that can be perceived, such as the ground, exterior walls, windows and doors, furniture, and the like. A picture frame 240 attached to a wall, a floor, a table 230 placed on the ground, and the like are shown in FIG. 2. The user 220 of the virtual reality system 100 may interact with the real scenario 210 through a virtual reality system. The user 220 may carry the virtual reality system 100. For example, when the virtual reality system 100 is a head-mounted virtual reality device, the user 220 wears the virtual reality system 100 on the head.

The visual perception device 120 (see FIG. 1) of the virtual reality system 100 captures the real-scenario image 260. When the user 220 wears the virtual reality system 100 on the head, the real-scenario image 260 captured by the visual perception device 120 of the virtual reality system 100 is an image observed from the perspective of the user's head. And as the posture of the user's head changes, the viewing angle of the visual perception device 120 also changes accordingly. In another embodiment, the relative pose of the user's hand relative to the visual perception device 120 may be obtained by capturing the image of the user's hand by the visual perception device 120, and the pose of the user's hand can then be obtained based on the pose of the visual perception device 120. In Chinese patent application 201110100532.9, a solution of using the visual perception device to obtain the hand pose of a hand is provided. The user's hand posture can also be obtained by other manners. In still another embodiment, the user 220 holds the visual perception device 120, or the visual perception device 120 is disposed on the user's hand, so that the user can utilize the visual perception device 120 to capture real-scenario images from a variety of different locations.

The scenario image 215 of the real scenario 210 observable by the user 220 is included in the real-scenario image 260. The scenario image 215 includes, for example, an image of a wall, a frame image 245 of the frame 240 attached to the wall, and a table image 235 of the table 230. The real-scenario image 260 also includes a hand image 225. The hand image 225 is an image of the hand of the user 220 captured by the visual perception device 120. In the virtual reality system, the user's hand is incorporated into the constructed virtual reality scenario.

The wall in real-scenario image 260, the frame image 245, the table image 235, and the hand image 225 may all be features in the scenario image 260. The visual processing device 160 (see FIG. 1) processes the real-scenario image 260 to extract features in the real-scenario image 260. In one example, the visual processing device 160 performs edge analysis on the real-scenario image 260 to extract the edges of the plurality of features of the real-scenario image 260. Methods for extracting edges include but are not limited to the methods provided in “A Computational Approach to Edge Detection” (J. Canny, 1986) and “An Improved Canny Algorithm for Edge Detection” (P. Zhou et al., 2011). On the basis of the extracted edges, the visual processing device 160 determines one or more features in real-scenario image 260. One or more features include location and orientation information. The orientation information includes pitch, yaw, roll angle information. Location and orientation information can be absolute location information and absolute orientation information. The location and orientation information may also be relative location information and relative orientation information relative to the vision acquisition device 120. Furthermore, with one or more features and the expected location and the expected orientation of the vision acquisition device 120, the scenario generation device 150 can determine the expected characteristics of the one or more features, such as the relative expected location and the relative expected orientation of one or more features, relative to the expected location and the expected orientation of the vision acquisition device 120. The scenario generation device 150 then generates the real-scenario image to be captured by the visual capture device 120 at the expected orientation.

The real-scenario image 260 includes two types of features, a scenario feature and an object feature. The indoor scenario meets the Manhattan World Assumption under normal circumstances, that is, the image has a perspective characteristic. In the scenario, the intersecting X-axis and Y-axis represent the horizontal plane (parallel to the ground) and the Z-axis represents the vertical direction (parallel to the wall). After the edges of buildings parallel to the three axes are extracted into lines, these lines and their intersections can be used as scenario features. The features corresponding to the frame image 245 and the table image 235 belong to a scenario feature and the user's hand 220 corresponding to the hand image 225 does not belong to a part of the scenario but an object to be fused to the scenario and thus the features corresponding to the hand image 225 are thus referred to as object features. It is an object of embodiments of the invention to extract object features from the real-scenario image 260. Yet another object of embodiments of the invention is to determine the pose of the object to be fused into the scenario from the real-scenario image 260. It is still another object of the present invention to create a virtual reality scenario using the extracted features. Yet another object of the present invention is to incorporate the objects into the created virtual scenario.

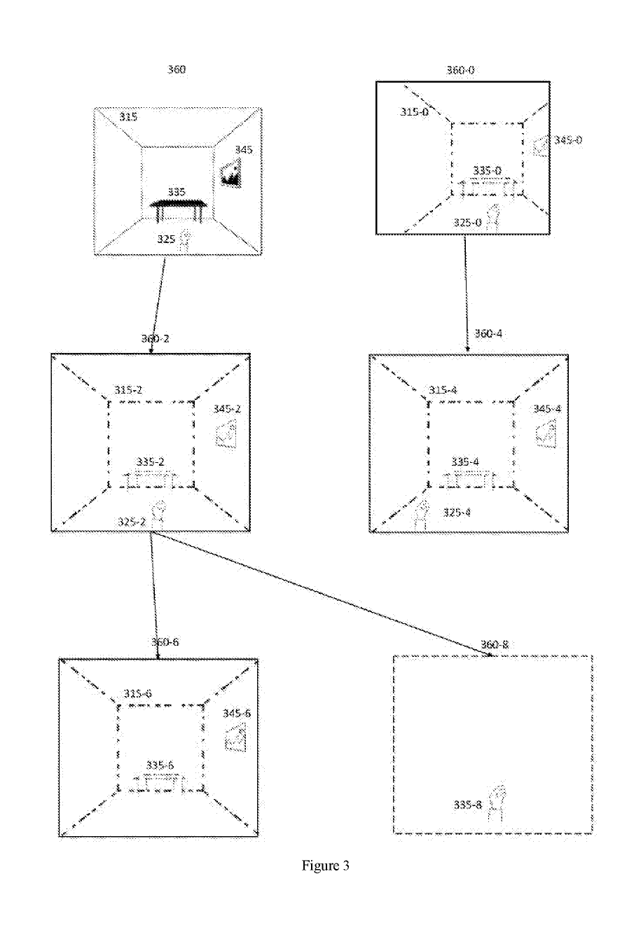

FIG. 3 is a schematic diagram illustrating a scenario feature extraction according to an embodiment of the present invention. The visual perception device 120 (see FIG. 1) of the virtual reality system 100 captures the real-scenario image 360. The scenario image 315 of the real scenario observable by the user 220 (refer to FIG. 2) is included in the real-scenario image 360. The real-scenario image 315 includes, for example, an image of a wall, a frame image 345 of a frame attached to the wall, and a table image 335 of the table. The real-scenario image 360 also includes a hand image 325. The visual processing device 160 (see FIG. 1) processes the real-scenario image 360 and extracts the feature set in the real-scenario image 360. In one example, edges of the features in the real-scenario image 360 are extracted by edge detection, and then the feature set in the real-scenario image 360 is determined.

At a first moment, the visual perception device 120 (see FIG. 1) of the virtual reality system 100 captures a real-scenario image 360 and the visual processing device 160 (see FIG. 1) processes the real-scenario image 360 to extract the feature set 360-2 in the real-scenario image 360. The scenario feature 315-2 is included in the feature set 360-2 of the real-scenario image 360. The scenario feature 315-2 includes a frame feature 345-2 and a table feature 335-2. The feature set 360-2 also includes the user's hand features 325-2.

At a second moment different from the first moment, the visual perception device 120 (see FIG. 1) of the virtual reality system 100 captures a real-scenario image (not shown) and the visual processing device 160 (see FIG. 1) processes the real-scenario image and extracts the feature set 360-0 in the real-scenario image 360. The scenario feature 315-0 is included in the feature set 360-0 of real-scenario image. The scenario feature 315-0 includes frame features 345-0 and table features 335-0. The feature set 360-0 also includes user hand features 325-0.

In an embodiment according to the present invention, the virtual reality system 100 integrates a motion sensor for sensing the state of movement of the virtual reality system 100 over time. Through the motion sensor, the location change and orientation change of the virtual reality system during the first moment and the second moment are obtained, particularly the change of the location and orientation of the visual perception device 120. According to the change of the location and the orientation of the visual perception device 120, the estimated location and the estimated orientation of the feature in the feature set 360-0 at the first moment are obtained. The estimated feature set at the first moment estimated based on the feature set 360-0 is shown in the feature set 360-4 of FIG. 3. In a further embodiment, a virtual reality scenario is also generated based on the estimated features in the estimated feature set 360-4.

In one embodiment, the motion sensor and the visual perception device 120 are fixed together, and the movement state of the visual perception device 120 over time can be directly obtained by using the motion sensor. The visual perception device may be disposed at the head of the user 220 so as to facilitate generating a real-time scenario as viewed from the perspective of the user 220. The visual perception device may also be disposed on the hand of the user 220 so that the user may conveniently move the visual perception device 120 to capture the real-scenario image from a plurality of different perspectives to utilize the virtual reality system for indoor locating and scenario modeling.

In another embodiment, the motion sensor is integrated in other locations of the virtual reality system. The absolute location and/or absolute orientation of the visual perception device 120 in the real scenario may be determined according to the movement state sensed by the motion sensor and the relative location and/or orientation of the motion sensor and the visual perception device 120.

The estimated scenario feature 315-4 is included in the estimated feature set 360-4. The estimated scenario features 315-4 include the estimated frame characteristics 345-4, and the estimated table features 335-4. The estimated feature set 360-4 also includes the estimated user′ hand feature 325-4. The estimated feature set 360-4 also includes an estimated user's hand feature 325-4.

Comparing the feature set 360-2 of the real-scenario image 360 acquired at the first moment with the estimated feature set 360-4, where the scenario feature 315-2 has the same or similar location and/or orientation as the estimated scenario feature 315-4, while the location and/or orientation difference between the user's hand feature 325-2 and the estimated user's hand feature 325-4 is greater. This is because an object such as a user's hand does not belong to a part of a scenario whose motion mode is different from the motion mode of the scenario.

In an embodiment of the invention, the first moment precedes the second moment. In another embodiment, the first moment is after the second moment.

Thus, features in the feature set 360-2 of the real-scenario image 360 captured at the first moment are compared with the estimated features in the estimated feature set 360-4. The scenario feature 315-2 has the same or similar location and/or orientation as the estimated scenario feature 315-4. In other words, the difference between the location and/or orientation of the scenario feature 315-2 and the estimated scenario feature 315-4 is smaller. Thus, such features are identified as scenario features. Specifically, in the real-scenario image 360 captured at the first moment, the location of the frame feature 345-2 is in the vicinity of the estimated frame feature 345-4 in the estimated feature set 360-4, and the table feature 335-2 is located near the estimated table feature 335-4 in the estimated feature set 360-4. However, the location of the user's hand feature 325-2 in the feature set 360-2 is further away from the estimated location of the user's hand feature 325-4 in the estimated feature set 360-4. Thus, it is determined that the frame feature 345-2 and the table feature 335-5 in the feature set 360-2 are scenario features, and the hand feature 325-2 is an object feature.

With continued reference to FIG. 3, the determined scenario features 315-6 are illustrated in the feature set 360-6, including the frame features 345-6 and the table features 335-6. The determined object features are shown in the feature set 360-8, including the user hand features 335-8. In a further embodiment, the location and/or orientation of the visual perception device 120 may be obtained by integrating the motion sensor and the relative location and/or orientation of the user's hand relative to the visual perception device 120 may be obtained from the user's hand feature 335-8, so as to obtain the absolute location and/or absolute orientation of the user's hand in the real scenario.

In a further embodiment, a user's hand feature 335-8 that is an object feature and the scenario feature 315-6 that includes frame features 345-6 and table features 335-6 are marked. For example, the respective location of the hand features 335-8 and the scenario features 315-6 including frame features 345-6 and table features 335-6 or the shape of each feature is marked, so that the user's hand features and the scenario features including frame features and table features are identified in the real-scenario image captured at other moments. Thus the virtual reality system can still distinguish the scenario feature from the object feature according to the marked information even though the object such as the user's hand is temporarily still relative to the scenario within a certain time interval. In addition, by updating the location/orientation of the marked features, that is, the marked features are updated according to the pose changes of the visual perception device 120, the scenario features and object features in the captured images can still be effectively distinguished during the relatively stationary period between the user's hand and the scenario.

FIG. 4 is a flow chart of a scenario feature extraction method according to an embodiment of the present invention. In the embodiment of FIG. 4, at a first moment, the visual perception device 120 (see FIG. 1) of the virtual reality system 100 captures the first image (410) of the real scenario. The visual processing device 160 (see FIG. 1) of the virtual reality system extracts one or more first features from the first image, each first feature having a first location (420). In one embodiment, the first location is the relative location of the first feature relative to the vision perception device 120. In another embodiment, the first location is the absolute location of the first feature in the real scenario. In yet another embodiment, the first feature has a first pose. The first pose may be a relative pose of the first feature relative to the visual perception device 120 or an absolute pose of the first feature in a real scenario.

At the second moment, the first estimated location of one or more first features at a second moment is estimated based on the movement information (430). In one embodiment, the location of the visual perception device 120 at any moment is obtained by GPS. The motion sensor obtains more accurate movement state information of the visual perception device 120 so as to obtain the change of the location and/or orientation of the one or more first features between the first moment and the second moment thus obtaining the location and/or orientation at the second moment. In another embodiment, the initial location and/or orientation of the visual perception device and/or the one or more first features are provided upon initialization of the virtual reality system. And the movement state of the visual perception device and/or the one or more first features over time is obtained through the motion sensor, and the location and/or orientation of the motion sensing device and/or the one or more first features at the second moment is obtained.

In still another embodiment, the first estimated location of one or more first features at the second moment is estimated at the first moment or other moment different from the second moment. Under normal conditions, the movement state of one or more of the first features does not change dramatically. When the first moment is close to the second moment, the location and/or orientation of the one or more first features at the second moment may be predicted or estimated based on the state of the movement at the first moment. In still another embodiment, the location and/or orientation of the first feature at the second moment is estimated at the first moment using the known movement pattern of the first feature.

With continued reference to FIG. 4, in an embodiment according to the invention, the second image (450) of the real scenario is captured by the visual perception device 120 (see FIG. 1) at a second moment. The visual processing device 160 (see FIG. 1) of the virtual reality system extracts one or more second features from the second image, with each second feature having a second location (460). In one embodiment, the second location is the relative location of the second feature relative to the visual perception device 120. In another embodiment, the second location is the absolute location of the second feature in the real scenario. In still another embodiment, the second feature has a second pose. The second pose may be the relative pose of the second feature relative to the visual perception device 120 or the absolute pose of the second feature in the real scenario.

One or more second features whose second location is located near (including the same with) the first estimated location are selected as the scenario features (470) in the real scenario. And one or more second features with the second location that are not located in the vicinity of the first estimated location are selected as object features. In another embodiment according to the present invention, the second feature whose second location is near the first estimated location and whose second orientation is similar (including the same) as the first estimated orientation is selected as the scenario feature in the real scenario. And one or more second features whose second location is not near the first estimated location and/or one or more second features whose the second orientation has a larger distance from the first estimated orientation is selected as the object feature.

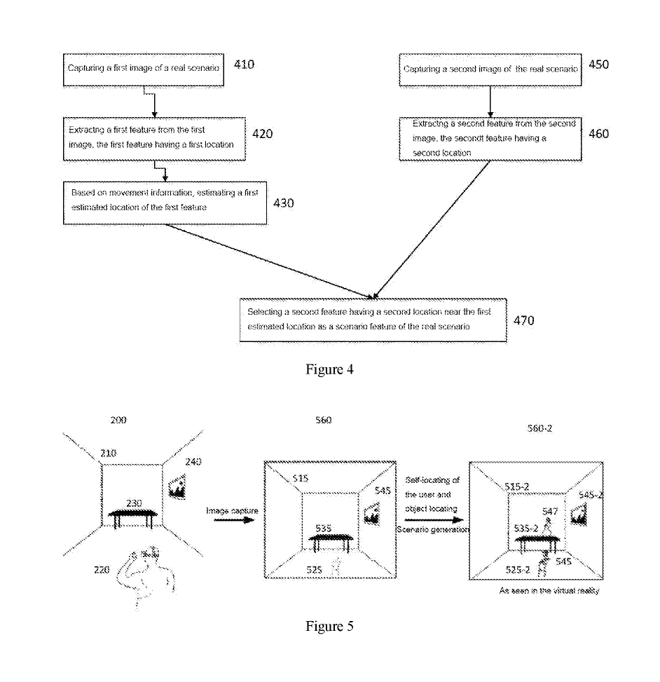

FIG. 5 is a schematic diagram of object locating of a virtual reality system according to an embodiment of the present invention. The application environment 200 of the virtual reality system 100 and the scenario image 560 captured by the visual perception device 120 (see FIG. 1) of the virtual reality system are shown in FIG. 5.

In the application environment 200, a real scenario 210 is included. The real scenario 210 may be in a building or other scenario that is stationary relative to the user or virtual reality system 100. The real scenario 210 includes a variety of objects or objects that can be perceived, such as the ground, exterior walls, windows and doors, furniture, and the like. A picture frame 240 attached to a wall, ground, a table 230 placed on the ground, and the like are shown in FIG. 5. The user 220 of the virtual reality system 100 may interact with the real scenario 210 through the virtual reality system. The user 220 may carry the virtual reality system 100. For example, when the virtual reality system 100 is a head-mounted virtual reality device, the user 220 wears the virtual reality system 100 on the head. In another example, the user 220 carries the virtual reality system 100 in the hand.

The visual perception device 120 (see FIG. 1) of the virtual reality system 100 captures the real-scenario image 560. When the user 220 wears the virtual reality system 100 on the head, the real-scenario image 560 captured by the visual perception device 120 of the virtual reality system 100 is an image observed from the perspective of the user's head. And as the posture of the user's head changes, the viewing angle of the visual perception device 120 also changes accordingly. In another embodiment, the relative pose of the user's hand relative to the user's head may be known, and he pose of the user's hand can then be obtained based on the pose of the visual perception device 120. In still another embodiment, the user 220 holds the visual perception device 120, or disposes the visual perception device 120 on the user's hand, so that the user can utilize the visual perception device 120 to capture real-scenario images from a variety of different locations.

The scenario image 515 of the real scenario 210 observable by the user 220 is included in the real-scenario image 560. The scenario image 515 includes, for example, an image of a wall, a frame image 545 of the frame 240 attached to the wall, and a table image 535 of the table 230. The real-scenario image 560 also includes a hand image 525. The hand image 525 is an image of the hand of the user 220 captured by the visual perception device 120. In the virtual reality system, the user's hand can be incorporated into the constructed virtual reality scenario.

The wall in the real-scenario image 560, the frame image 545, the table image 535, and the hand image 525 may all be features in the scenario image 560. The visual processing device 160 (see FIG. 1) processes the real-scenario image 560 to extract features in the real-scenario image 560.

There are two types of features in the real-scenario image 560, including scenario features and object features. The features corresponding to the picture frame image 545 and the table image 535 belong to the scenario features, while the hands of the user 220 corresponding to the hand image 525 are not a portion of the scene, but rather an object to be merged into the scene, thus the feature corresponding to the hand image 525 is referred to as object features. One object of the present invention is to extract the object features from the real-scenario image 560. One object of the present invention is to determine the location of an object from the real-scenario image 560. Another object of the present invention is to determine the pose of an object to be merged into the scene from the real-scenario image 560. Still another object of the invention is to create virtual reality scenes using the extracted features. It is yet another object of the present invention to incorporate objects into created virtual scenario.

Based on the scenario features determined from the real-scenario image 560, the pose of the scenario feature and that of the visual perception device 120 relative to the scenario feature can be determined, thereby determining the location and/or the orientation of the visual perception 120 itself. And the location and/or the orientation of the object is then determined by giving the relative pose of the object to be created in the virtual reality scene relative to the visual perception device 120.

Continuing with FIG. 5, the created virtual scenario 560-2 is shown. Virtual scenario 560-2 is created based on the real-scenario image 560, which includes a scenario image 515-2 that is observable by the user 220. The scenario image 515-2 includes an image, such as a wall, a frame image 545-2 attached to the wall, and a table image 535-2. And the virtual scenario 560-2 further includes a hand image 525-2. In one embodiment, virtual scenario 560-2, scenario image 515-2, frame image 545-2, and table image 535-2 are created from the real-scenario image 560. And the hand image 525-2 is generated in the virtual scenario 560-2 by the scenario generation device 150 based on the pose of the hand of the user 220. The pose of the hand of the user 220 may be the relative pose of the hand relative to the visual perception device 120, or the absolute pose of the hand in the real scenario 210.

In FIG. 5, a flower 545 and a vase 547 generated by scenario generation device 150 are also shown that are not present in the real scenario 210. The scene generation device 150 generates a flower 545 and a vase 547 in the virtual scenario 560-2 by giving the shape, texture and/or pose of the flower and/or vase. The hand of user 525-2 interacts with flower 545 and/or vase 547. For example, the hand portion of user 525-2 places flower 547 in vase 547 and generates the scene 560-2 that embodies this interaction through scene generation device 150. In one embodiment, the location and/or the orientation of user's hand in real scenario is captured in real time, and hand images of user 525-2 with captured locations and/or orientation are then generated in the virtual scenario 560-2. And generating a flower 545 in the virtual scenario 560-2 based on the location and/or the orientation of the user's hand, thereby to reveal the interaction of the user's hand with the flower.

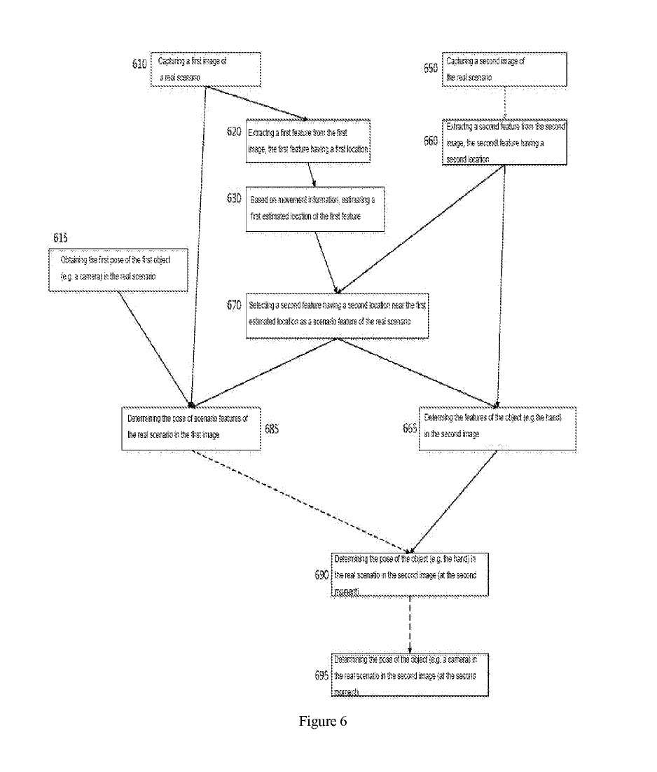

FIG. 6 is a flow chart of an object locating method according to an embodiment of the present invention. In the embodiment of FIG. 6, the visual perception device 120 (see FIG. 1) of the virtual reality system 610 captures the first image of the real scenario at a first moment (610). The visual processing device 160 (see FIG. 1) of virtual reality system extracts one or more first features from the first image, each having a first location (620). In one embodiment, the first location is the relative location of the first feature relative to visual perception device 120. In another embodiment, virtual reality system provides an absolute location of visual perception device 120 in real scenario, such as providing when the virtual reality system is initialized; in another example, the absolute location of visual perception device 120 in real scenario is provided by GPS, and further the absolute location and/or orientation of visual perception device 120 in real scenario is determined based on the motion sensor. On that basis, the first location can be the absolute location of the first feature in the real scenario. In still another embodiment, the first feature has a first pose, which can be a relative pose of the first feature relative to visual perception device 120, or an absolute pose of the first feature in the real scenario.

At the second moment, the first estimated location of the one or more first features at the second moment is estimated based on movement information (630). In one embodiment, the pose of visual perception device 120 at any time is obtained by GPS. More accurate motion state information is obtained by motion sensors to obtain changes in the location and/or the orientation of one or more first features between the first and second moments, thus to obtain a location and/or orientation at the second moment. In another embodiment, the initial location and/or orientation of visual perception device and/or one or more first features are provided when the virtual reality system is initialized. And the motion states of visual perception device and/or one or more first features are obtained through motion sensors, so as the location and/or the orientation of visual perception device and/or one or more first features at the second moment are obtained.

In still another embodiment, the first estimated location of one or more first features at the second moment is estimated at a first moment or other time point different from the second moment. Under normal circumstances, the motion state of one or more first features does not vary drastically, and when the first moment is closer to the second, the location and/or the orientation of one or more first features at the second moment can be predicted or estimated based on the motion state at the first moment. In still another embodiment, the location and/or the orientation of the first feature at the second moment is estimated at the first moment using a known motion pattern of the first feature.

With continued reference to FIG. 6, in an embodiment of the present invention, a second image of a real scenario is captured at the second moment by the visual perception device 120 (see FIG. 1) (650). The visual perception device 160 (see FIG. 1) of virtual reality system extracts one or more second features from the second image, each of which has a second location (660). In one embodiment, the second location is the relative location of the second feature to the visual perception device. In another embodiment, the second location is the absolute location of the second feature in the real scenario. In still another embodiment, the second feature has a second pose, which can be a relative pose of the second feature to visual perception device 120, or an absolute pose of the second feature in the real scenario.

The one or more second features whose the second location located near (including the same as) the first estimated location are selected as the scenario features in real scenario (670). And the one or more second features of the second location not near the first estimated location are selected as the object features in real scenario. In an another embodiment of the present invention, when the second location is located near or in the first estimated location while the second orientation is similar to (or the same as) the first orientation, the second features with the second location and the second orientation are selected as the scenario features in real scenario. And the one or more second features are selected as the object features when the second location of the second feature is not located near the first estimated location and/or the second orientation of the second feature is far different from the first orientation.

A first pose of the first object in the real scenario such as of the visual perception device 120 of virtual reality system 100, is acquired (615). In one embodiment, the initial pose of the visual perception device 120 is provided when the virtual reality system 100 is initialized. And the pose variation of the visual perception device 120 is provided by motion sensor, thereby obtaining the first pose of the visual perception device 120 in the real scenario at the first moment. And in an example, the first pose of the visual perception device 120 in the real scenario at the first moment is obtained by GPS and/or motion sensors.

In step 620, each of the first features and/or pose of the first feature has been obtained, which may be a relative location and/or a relative pose of each first feature and the visual perception device 120. And an absolute pose of each first feature in the real scenario can be acquired on the basis of the first pose of the visual perception device 120 in the real scenario at the first moment. While in step 670, a second feature served as the scenario feature in the real scenario has already been obtained. And the pose of the scenario feature of the real scene in the first image is further determined (685).

In step 670, a second feature served as the scenario feature in the real scenario has already been obtained. The feature of the object such as in the user's hands is determined in the same way (665). For instance, the one or more second features with the second location not near the first estimated location are selected as the object features in real scenario. In another embodiment of the present invention, the one or more second features are selected as the object features when the second location of the second feature is not located near the first estimated location and/or the second orientation of the second feature is far different from the first orientation.

In step 665, a feature of an object, such as a user's hand, has been obtained, and according to the feature, the relative location and/or orientation of the object, such as the user's hand, relative to the visual perception device 120 is obtained. And in step 615, a first pose of the visual perception device 120 in the real scenario has been obtained. Therefore, the absolute location and/or the orientation of the object, such as the user's hand, and the visual perception device 120 in the real scenario at the second moment when capturing the second image is obtained on the basis of both the first pose of the visual perception device 120 and the relative location and/or the orientation of the object, such as the user's hand, to the visual perception device 120 (690).

In another embodiment, at step 685, the location and/or the orientation of the scenario features of the real scenario in the first image has been obtained. And in step 665, a feature of an object in the second image, such as a user's hand, has been obtained, from which the relative location and/or orientation of the object, such as the user hand, and the scenario features, is obtained. Therefore, the absolute location and/or the orientation of the object, such as the user's hand, in the real scenario at the second moment of capturing the second image is obtained on the basis of the location and/or the orientation of the scenario features and the relative location and/or the orientation of the object, such as the user's hand, to the scenario features in the second image (690). The pose of the user's hand at the second moment is determined by the second image, which is conducive to the location accuracy by avoiding the error using the sensor.

In a further alternative embodiment, the absolute location and/or the orientation of the visual perception device 120 in the real scenario at the second moment of capturing the second image is obtained on the basis of both the absolute location and/or the orientation of the object, such as the user's hand in the real scenario at the second moment of capturing the second image, and the relative location and/or the orientation of the object, such as the user's hand, to the visual perception device 120 (695). In a still further alternative embodiment, the absolute location and/or the orientation of the visual perception device 120 in the real scenario at the second moment of capturing the second image is obtained on the basis of both the absolute location and/or the orientation of the object, such as a picture frame or a table in the real scenario at the second moment of capturing the second image, and the relative location and/or the orientation of the object, such as a picture frame or a table, to the visual perception device 120 (695). The pose of the visual perception device 120 at the second moment is determined by the second image, which is conducive to the location accuracy by avoiding the error using the sensor.

In an embodiment according to another aspect of the invention, based on the location and/or the orientation of the visual perception device 120, object features, and/or scenario features at the second moment, virtual reality scenario is generated using scenario generation device 150 of virtual reality system.

In a further embodiment according to another aspect of the invention, an object that does not exist in real scenario, such as a vase, is generated in virtual reality scenario based on a specified pose, and the interaction of user's hands with the vase in the virtual reality scenario will change the pose of the vase.

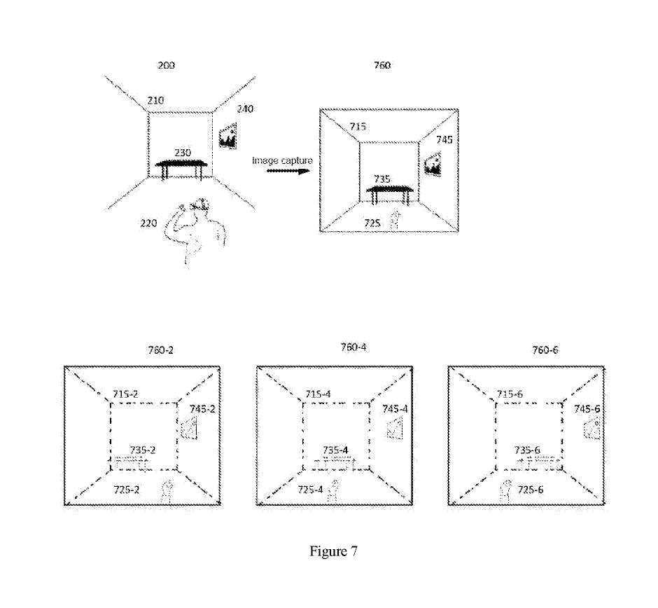

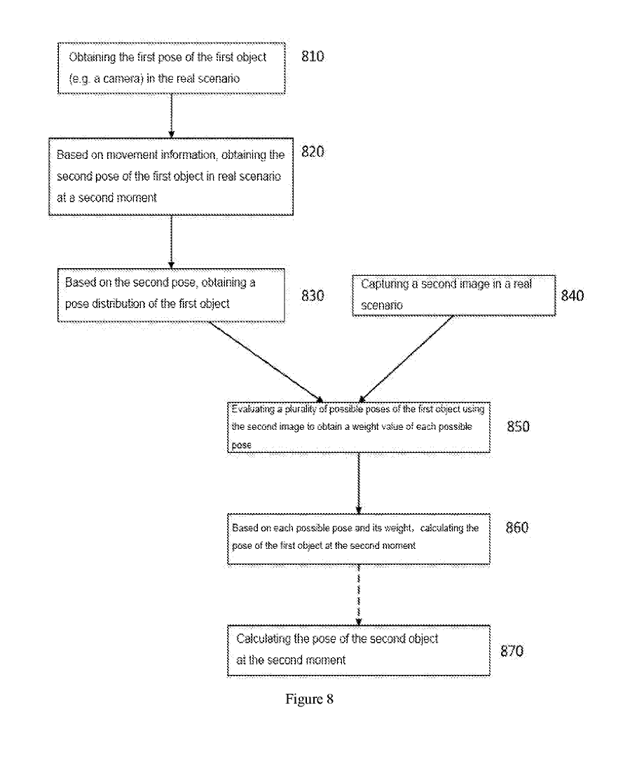

FIG. 7 is a schematic diagram of an object locating method according to another embodiment of the present invention, in the embodiments of which the location of visual perception device is accurately determined. And FIG. 7 shows an application environment 200 of virtual reality system as well as a scenario image 760 captured by the visual perception device 120 (see FIG. 1) of virtual reality system.

In the application environment 200, a real scenario 210 is included, which includes a variety of objects or targets that can be perceived, e.g., ground, exterior walls, doors and windows, furniture, and the like. FIG. 7 shows a frame 240 attached to the wall, a ground, a table 230 placed on the ground, etc. The user 220 of virtual reality system 220 may interact with real scenario 210 through a virtual reality system. And the user 220 may carry virtual reality system 100. For example, user 220 wears virtual reality system 100 on head when virtual reality system 100 is a head-mounted virtual reality device. In another example, the user 220 carries the virtual reality system 100 in hand.

The visual perception device 120 (see FIG. 1) of virtual reality system 100 captures the real-scenario image 760. When the user 220 wears the virtual reality system 100 on the head, the real-scenario image 760 captured by the visual perception device 120 of virtual reality system 100 is an image observed from the perspective of the user's head. And changes in viewing angle of the visual perception device 120 will be taken accordingly with changes of the user's head pose.

The real-scenario image 760 includes a scenario image 715 of the real scenario 210 that is observable by the user 220. The scenario image 715 includes an image of such as a wall, a frame image 745 of the frame 240 attached to the wall, and a table image 735 of the table 230. The real-scenario image 760 further includes a hand image 725, which is an image of hand of user 220 captured by the visual perception device 120.

In the embodiment of FIG. 7, the first location and/or the orientation information of the visual perception device 120 in the real scenario can be acquired according to the movement information provided by motion sensor. However, movement information provided by the motion sensor may present errors. On the basis of the first location and/or the orientation information, estimating a plurality of locations or the orientations that the visual perception device 120 may have. And based on the first location and/or the orientation the visual perception device 120 may have, generating a first real-scenario image 760-2 of the real scenario to be observed by the visual perception device 120; based on the second location and/or the orientation the visual perception device 120 may have, generating a second real-scenario image 760-4 of the real scenario to be observed by the visual perception device 120; and based on the third location and/or the orientation the visual perception device 120 may have, generating a third real-scenario image 760-6 of the real scenario to be observed by the visual perception device 120.

The first real-scenario image 760-2 includes a scenario image 715-2 to be observed by the user 220. The scenario image 715-2 includes an image of such as a wall, a frame image 745-2, and a table image 735-2. The first real-scenario image 760-2 further includes a hand image 725-2. The second real-scenario image 760-4 includes a scenario image 715-4 to be observed by the user 220. The scenario image 715-4 includes an image of such as a wall, a frame image 745-4, and a table image 735-4. The second real-scenario image 760-4 further includes a hand image 725-4. The third real-scenario image 760-6 includes a scenario image 715-6 to be observed by the user 220. The scenario image 715-6 includes an image of such as a wall, a frame image 745-6, and a table image 735-6. The third real-scenario image 760-6 further includes a hand image 725-6.

The real-scenario image 760 is the real-scenario image actually observed by the motion sensor 120. The real-scenario image 760-2 is an estimated real-scenario image observed by the motion sensor in the first location. The real-scenario image 760-4 is an estimated real-scenario image observed by the motion sensor in the first location. And the real-scenario image 760-6 is an estimated real-scenario image observed by the motion sensor in the first location.

By comparison of the real-scenario image actually observed by the motion sensor 120 with the estimated first real-scenario image 760-2, the second real-scenario image 760-4 and the third real-scenario image 760-6, it is showed that the closest image to the actual real-scenario image 760 is the second real-scenario image 760-4. Accordingly, the second location corresponding to the second real-scenario image 760-4 may be the representative of the actual location of the motion sensor 120.

In another embodiment, the similarity degree of the first real-scenario image 760-2, the second real-scenario image 760-4, the third real-scenario image 760-6 respectively to the actual real-scenario image 760 is served as the first, second and third weight value respectively of the first real-scenario image 760-2, the second real-scenario image 760-4, the third real-scenario image 760-6. And the weighted average of the first, second and third location is taken as the location of visual perception device 120. In another embodiment, the orientation of the visual perception device 120 is determined in a similar way.

In still another embodiment, one or more features are extracted from the real-scenario image 760. And features of the real scenario respectively observed by visual perception device in the first, second and third location are estimated according to the first, second and third location. And the orientation of visual perception device 120 is calculated based on the similarity degree between one or more features in the real-scenario image 760 and the estimated features.

FIG. 8 is a flow chart of an object locating method according to another embodiment of the present invention. In the embodiment of FIG. 8, the first pose of the first object in the real scenario is obtained (810). As an example, the first object is the visual perception device 120 or a hand of the user. Based on movement information, the second pose (820) of the first object in the real scenario at the second moment is obtained (820). The pose of the visual capture device 120 is acquired by integrating the motion sensor into visual capture device. In one embodiment, the initial pose of the visual perception device 120 is provided when the virtual reality system 100 is initialized. And the first pose of the visual perception device 120 in the real scenario at the first moment as well as the second pose of the visual perception device 120 in the real scenario at the second moment are obtained through the pose changes of the visual perception device 120 provided by motion sensors. In one embodiment, the first pose of the visual perception device 120 in the real scenario at the first moment as well as the second pose of the visual perception device 120 in the real scenario at the second moment are obtained by GPS and/or motion sensors. And in the embodiments of the present invention, a first pose of visual perception device in the real scenario is obtained by performing the object locating method of embodiments of the invention, and a second pose of visual perception device 120 in the real scenario at the second moment is obtained by GPS and/or motion sensors.

Due to the presence of errors, the second pose obtained by the motion sensor may be inaccurate. To achieve an accurate second pose, the second pose is processed to gain a pose distribution of the first object at the second moment (830). The pose distribution of the first object at the second moment refers to a collection of poses that the first object may have at a second moment. The first object may have a pose in the set at different probabilities. In one embodiment, the pose of the first object is uniformly distributed in the set, while in another example, the pose of the first object is distributed in the set based on historical information, and in still another example, the distribution of the pose of the first object in the set is determined based on the movement information of the first object.

At the second moment, the second image of the real scenario is further captured by visual perception device 120 (840). The second image 840 is an image of the real scenario actually captured by visual perception device 120 (see the real-scenario image 760 of FIG. 7).

Two or more possible poses are selected from the pose distribution of the first object at the second moment, and a plurality of possible poses of the first object are evaluated using the second image to obtain a weight of each possible pose (850). In one embodiment, two or more possible poses are selected in a random manner from the pose distribution of the first object at the second moment. In another embodiment, two or more possible poses are selected according to the probability of their occurrences. In one embodiment, the first location, second location, and third location of the first object at the second moment are estimated from the pose distribution of the first object at the second moment. And the real-scenario images observed by visual perception device at the first location, the second location and the third location are estimated. The real-scenario image 760-2 (see FIG. 7) is the estimated real-scenario image observed by the motion sensor 120 at the first location. The real-scenario image 760-4 is the estimated real-scenario image observed by the motion sensor 120 at the second location. The real-scenario image 760-6 is the estimated real-scenario image observed by the motion sensor 120 at the third location.

The pose (860) of visual perception device 120 at the second moment is calculated according to each possible location and/or orientations of the visual perception device 120, as well as the weight value of each possible location and/or orientation (860). In one embodiment, the actual real-scenario image 760-2 observed by the motion sensor 120 is compared with the estimated first real-scenario image 760-2, second real-scenario image 760-4, and the third real-scenario image 760-6, which shows that the closest image to the actual real-scenario image 760 is the second real-scenario image 760-4. Accordingly, the second location corresponding to the second real-scenario image 760-4 may be the representative of the actual location of the motion sensor 120. In another embodiment, the similarity degree of the first real-scenario image 760-2, the second real-scenario image 760-4, the third real-scenario image 760-6 respectively to the actual real-scenario image 760 is served as the first, second and third weight value respectively of the first real-scenario image 760-2, the second real-scenario image 760-4, the third real-scenario image 760-6. And the weighted average of the first, second and third location is taken as the location of visual perception device 120. In another embodiment, the orientation of the visual perception device 120 is determined in a similar way.

The pose (870) of other objects in the virtual reality system at the second moment is further determined on the basis of the obtained pose of the visual perception device (870). For example, calculating the pose of the user's hand based on both the pose of the visual perception device, and the relative pose of the user's hand to the visual perception device.

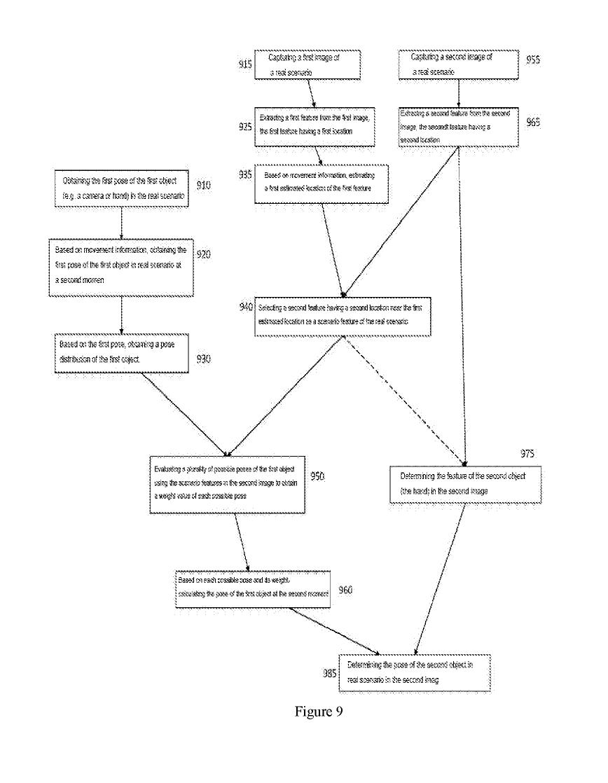

FIG. 9 is a flow chart of an object locating method according to still another embodiment of the present invention. In the embodiment of FIG. 9, the first pose (910) of the first object in the real scenario is obtained (910). As an example, the first object is visual perception device 120 or the user's hand. Based on movement information, the second pose (920) of the first object in real scenario at a second moment is obtained (920). The pose of the visual capture device 120 is obtained by integrating the motion sensor into the visual capture device 120.

Due to the presence of errors, the second pose obtained by the motion sensor may be inaccurate. To obtain the accurate second pose, the second pose is processed, thereby obtaining a pose distribution of the first object at the second moment (930).

In the embodiment of the present invention, a method of obtaining scenario features is provided. In the embodiment of FIG. 9, at a first moment, for example, the first image of the real scenario is captured by the visual perception device 120 of the virtual reality system 100 (915). One or more first features from the first image is extracted by the visual processing device 160 (see FIG. 1) of virtual reality system, each having a first location (925). In one embodiment, the first location is a relative location of the first feature to the visual perception device 120. In another embodiment, an absolute location of the visual perception device 120 in real scenario is provided by the virtual reality system. In still another embodiment, the first feature has a first pose, which may be a relative pose of the first feature to the visual perception device 120, or an absolute pose of the first feature in the real scenario.

At the second moment, the first estimated location of one or more first features at the second moment is estimated based on movement information (935). In one embodiment, the pose of visual perception device 120 at any moment is obtained by GPS. More accurate motion state information is acquired by motion sensors such that changes in the location and/or orientation of one or more first features between the first and second moment are obtained, thereby obtaining a location and/or orientation at the second moment.

With continued reference to FIG. 9, in an embodiment of the present invention, a second image of a real scenario is captured by visual perception device 120 (see FIG. 1) at the second moment (955). One or more second features are extracted by the visual processing device 160 of virtual reality system (see FIG. 1) from the second image, each having a second location (965).

One or more second features with the second location located near (or in) the first estimated location are selected as scenario features of real scenario (940). And one or more second features with the second location not located near the first estimated location are selected as object features.

From the pose distribution of the first object at the second moment, two or more possible poses are selected, and a plurality of possible poses of the first object is evaluated using the scenario features in the second image to obtain a weight value of each possible pose (950). In one embodiment, the possible first location, second location, and third location of the first object at the second moment are estimated from the pose distribution of the first object at the second moment. And scenario features of the real-scenario image observed by visual perception device 120 at the first location, the second location and the third location are estimated.

The pose (960) of visual perception device at the second moment is calculated based on each estimated possible location and/or orientation of the visual perception device 120 as well as the weight of each possible location and/or orientation (960). In step 940, a second feature of the scenario feature taken in the real scenario is already obtained. Features of the object such as the user's hands in the second image are determined in a similar way (975).

Based on the obtained poses of visual perception device in the step 960, the pose (985) of other objects in the virtual reality system at a second moment is further determined (985). For example, the pose of the user's hand is calculated on the basis of the pose of visual perception device as well as the relative pose between the user's hand and visual perception device. And the hand images in the virtual scenario are generated by the scenario generation device 150 according to the pose of the user 220's hands.

In an another embodiment of the present invention, the image of scenario features and/or object features corresponding to visual perception device with the at the second moment is generated in a virtual scenario in a similar manner.

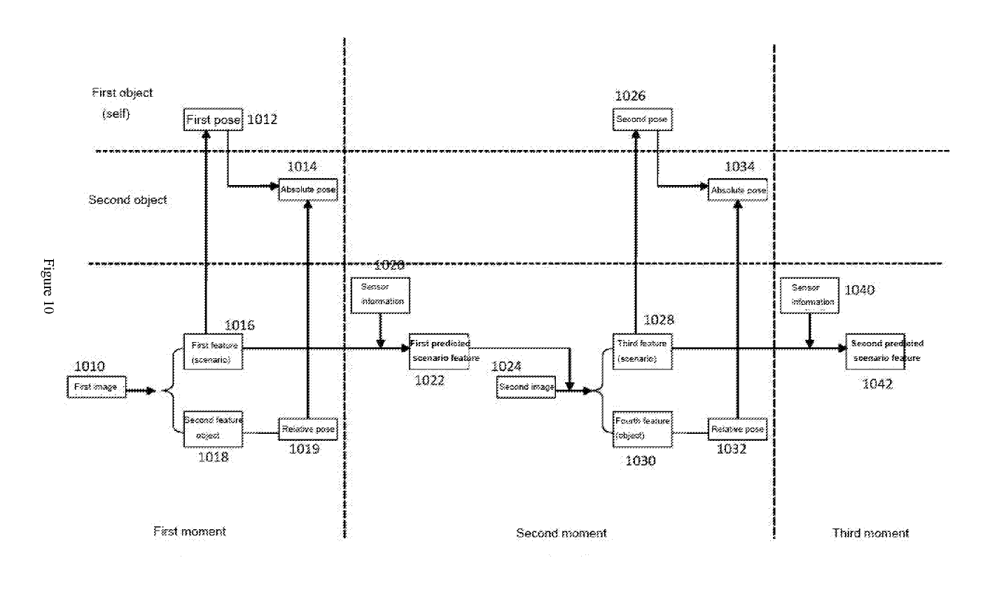

FIG. 10 is a schematic of feature extraction and object locating according to embodiments of the present invention. With reference to FIG. 10, the first object is, for example, a visual perception device or a camera. At the first moment, the first object has a first 1012, which can be obtained in various ways. For example, a first pose 1012 is obtained by GPS and motion sensors, and the first pose 1012 of the first object is obtained by methods based on the embodiment of the present invention (see FIG. 6, FIG. 8 or FIG. 9). The second object in FIG. 10 is, for example, a user's hand or an object in a real scenario (e.g. a picture frame, a table). The second object may also be a virtual object in a virtual reality scenario, such as a vase, flowers, etc. The relative pose between the second object and the first object can be determined through the image captured by the visual perception device, and further the absolute pose 1014 of the second object at the first moment is obtained based on the obtained first pose of the first object.

At the first moment, the first image 1010 of the real scenario is captured by the visual capture device. Features are extracted from the first image 1010, which can be divided into two categories. The first feature 1016 belongs to scenario features, and the second feature 1018 belongs to the object features. The relative pose between the object corresponding to the second feature and the first object (e.g. visual perception device) can also be obtained from the second feature 1018.

At the second moment, a first predicted scenario feature 1022 at the second moment of the first feature 1016 taken as scenario feature is estimated based on the sensor information 1020 indicating movement information of the visual perception device. At the second moment, the second image 1024 of the real scenario is further captured by the visual perception device. Features can be extracted from the second image 1024, which can be divided into two categories. The first feature 1016 belongs to scenario features, and the second feature 1018 belongs to the object features.

At the second moment, the first predicted scenario feature 1022 is compared with the feature extracted from the second image, the feature near the first predicted scenario feature 1022 is treated as a third feature 1028 representing the scenario feature, and the feature not near the first predicted scenario feature 1022 is treated as a fourth feature 1030 representing the scenario feature.

At the second moment, a relative pose of visual capture device to the third feature (1028) taken as the scenario feature is obtained through the second image, thereby obtaining the second pose 1026 of visual capture device. A relative pose 1032 of visual capture device to the fourth feature (1030) taken as the object feature can also be obtained through the second image, thereby obtaining an absolute pose 1034 of second object at the second time. The second object can be an object corresponding to the fourth feature or an object to be generated in a virtual reality scenario.

At the third moment, a second predicted scenario feature 1042 at the third moment of the third feature 1028 taken as scenario feature is estimated based on the sensor information 1040 indicating movement information of the visual perception device.

Although the first moment, second moment and third moment are shown in FIG. 10, it will be appreciated by those skilled in the art that the embodiments according to the present invention will continuously capture the scenario images, extract features, acquire motion sensor information at any moment, and distinguish the scenario feature and object feature, determining the location and/or the orientation of each object and feature, and generating the virtual reality scenario.

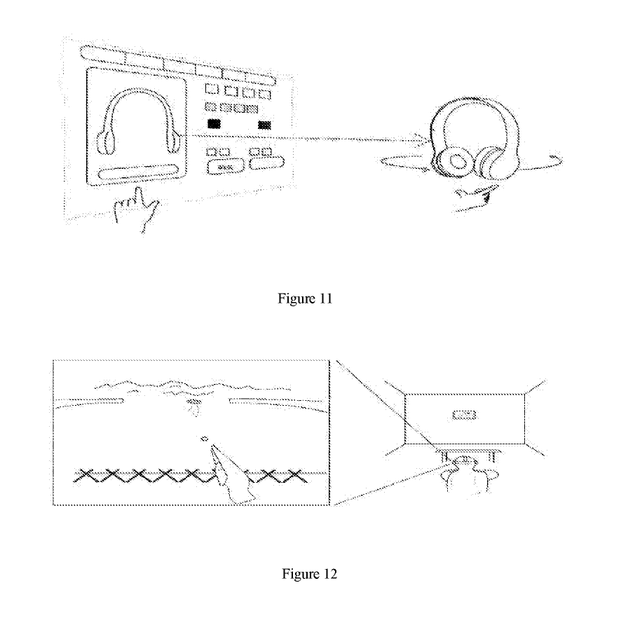

FIG. 11 is a schematic of an application scenario of a virtual reality system according to the embodiment of the present invention. In the embodiment of FIG. 11, the virtual reality system according to the embodiments of the present invention is applied to a shopping guide scenario to enable users to experience interactive shopping in a three-dimensional environment. In the application scenario of FIG. 11, users can purchase online by the virtual reality system according to the present invention. The user can look through online goods on a virtual browser in the virtual world, and “select” and “pick out” the interested commodity (e.g., the headset) from the interface for careful observation. The three-dimensional scan model of the commodity can be preserved by the shopping guide website in advance. And the three-dimensional model corresponding to the commodity that is selected by users will be automatically found by the website after the selection, which can be displayed floating at the front of the virtual browser through the present system.

Since gestures of users can be identified due to accurate locating and tracking uses' hands by the system, users are allowed to perform operation on the model. For example, a single click on model represents the selection; two fingers pinching the model indicates the rotation; three fingers or above grasping the model represents the motion. If the user is satisfied with the commodity, they can order through the virtual browser, and buy it on line. Such interactive browsing adds fun of online shopping for users, figuring out the existing problems that real objects cannot be observed in online shopping, which improves the user's experience.

FIG. 12 is a schematic of an application scenario of a virtual reality system according to another embodiment of the present invention. In the embodiment of FIG. 12, the virtual reality system according to the embodiments of the present invention is applied to immersive interactive virtual reality games. In the application scenario of FIG. 12, a user plays virtual reality games through the virtual reality system according to the present invention, one of which is clay shooting. Users in this game are required to destroy as much flying saucer as possible with a shotgun while avoiding the saucers fling to themselves. The user in a real empty room will be “placed” by the system to a virtual world through a self-locating technology, as to the wild environment shown in FIG. 12. And the virtual world will be presented in front of the user. The user can turn his head and move his body to view the entire virtual world.

Through a self-location of the user, the scenario is rendered by the system in real time, enabling the user to feel the movement in the scenario; and through the locating of the user's hands, the gunshot in the hands is moved accordingly in the virtual world, enabling the user to feel like a real gunshot in the hands. And the locating and tracking of the user's fingers enable the gesture recognition of whether the shotgun is fired or not. And the system can determine whether the flying saucer is hit or not through the direction of the user's hand With regard to other virtual reality games with stronger interaction, the system can detect the dodge direction of the user by locating the user's body, thereby to avoid the attack of the virtual game character.

For the purposes of illustration and description, this invention have been described herein, and it is not intended to be exhaustive or to limit the invention in the form disclosed. Many modifications and variations will be apparent to those skilled in the art.

1. A scenario extraction method comprising:
capturing a first image of a real scenario;
extracting a plurality of first features from the first image, each of the plurality of the first features having a first location;
capturing a second image of the real scenario, and extracting a plurality of second features from the second image; each of the plurality of the second features having a second location;
based on the movement information, estimating a first estimated location of each of the plurality of the first features using the plurality of the first locations;
selecting the second feature having the second location near the first estimated location as a scenario feature of the real scenario.

2. A scenario extraction method comprising:
capturing a first image of a real scenario;
extracting a first feature and a second feature from the first image, the first feature having a first location and the second feature having a second location;
capturing a second image of the real scenario, extracting a third feature and a fourth feature from the second image; the third feature having a third location and the fourth feature having a fourth location;
based on the movement information, estimating a first estimated location of the first feature and a second estimated location of the second feature using the first location and the second location;
if the third location being near the first estimated location, the third feature being taken as a scenario feature of the real scenario; and/or if the fourth location being near the second estimated location, the fourth feature being taken as a scenario feature of the real scenario.

3. The method according to claim 2, wherein,
the first feature and the third feature correspond to the same feature in the real scenario, and the second feature and the fourth feature correspond to the same feature in the real scenario.

4. The method according claim 1, wherein,
the step of capturing the second image of the real scenario is performed prior to the step of capturing the first image of the real scenario.

5. The method according to claim 1, wherein,
the movement information is the movement information of the image capture device for capturing the real scenario, and/or the movement information is the movement information of the object in the real scenario.

6.-8. (canceled)

9. A scenario extraction system comprising:
a first capture module for capturing a first image of a real scenario,
an extraction module for extracting a plurality of first features from the first image, each of the plurality of the first features having a first location,
a second capture module for capturing a second image from the real scenario, and extracting a plurality of second features from the second scenario, each of the plurality of the second features having a second location;
a location estimation module for estimating a first estimated location of each of the plurality of first features using the plurality of first locations based on the movement information;
a scenario feature extraction module for selecting the second feature having the second location near the first estimated location as a scenario feature of the real scenario.

10. (canceled)
